(19) United States
(12) Patent Application Publication
(10) Pub. No.: US 2015/0077643 A1
(43) Pub. Date: Mar. 19, 2015

(54) LIGHTING DEVICE, DISPLAY DEVICE, AND TELEVISION DEVICE

(71) Applicant: Sharp Kabushiki Kaisha, Osaka-shi, Osaka (JP)

(72) Inventors: Ryo Yamakawa, Osaka-shi (JP); Kuniaki Tanaka, Osaka-shi (JP)

(21) Appl. No.: 14/386,039

(22) PCT Filed: Mar. 27, 2013
(86) PCT No.: PCT/JP2013/058983

§ 371 Date: Sep. 18, 2014

(30) Foreign Application Priority Data
Apr. 3, 2012 (JP) 2012-084922

(51) Int. Cl. F21V 8/00; H04N 9/12

(52) U.S. Cl. CPC G02B 6/009; G02B 6/0068; H04N 9/12
USPC 348/791; 362/613; 349/65

(57) ABSTRACT

A backlight unit 12 (lighting device) includes LEDs (light sources) 17, a light guide plate 19, an LED board (light source board) 18, a chassis (mount member) 14 to which the LED board 18 is mounted, a screw member (board attachment member) 22, arrangement interval variation LEDs (arrangement interval variation light sources) 24. The light guide plate 19 includes an end surface (light entrance surface 19b) opposite the LEDs 17 and through which light from the LEDs 17 enters and a plate surface (light exit surface 19a) through which light exits. The LED board (light source board) 18 includes the LEDs 17 arranged at intervals along the end surface of the light guide plate 19. The screw member (board attachment member) 22 is arranged between the adjacent LEDs 17 to attach the LED board 18 to the chassis 14. The arrangement interval variation LEDs (arrangement interval variation light sources) 24 included in the LEDs 17 are arranged such that intervals P1 to P3 therebetween decrease as a distance from the screw member 22 increases.

### TECHNICAL FIELD

The present invention relates to a lighting device, a display device, and a television device.

### BACKGROUND ART

In recent years, displays in image display devices, such as television devices, are being shifted from conventional cathode-ray tube displays to thin displays, such as liquid crystal displays and plasma displays. With the thin displays, thicknesses of the image display devices can be decreased. Liquid crystal panels do not emit light. Therefore, liquid crystal display devices including liquid crystal panels require backlight devices. The backlight devices are classified broadly into a direct type and an edge-light type based on mechanisms. For further reduction in thicknesses of the liquid crystal display devices, the edge-light type backlight devices are more preferable. A backlight devices disclosed in Patent Document 1 is known as an example of the kind.

### RELATED ART DOCUMENT

### Patent Document

Patent Document 1: Japanese Unexamined Patent Publication No. 2011-232607

### Problem to be Solved by the Invention

In the above edge-light backlight unit, because light sources are arranged locally in an end portion of a chassis included in the backlight unit, it may be difficult to allocate a space for attaching the light sources to the chassis. Specifically, if LEDs are used as the light sources, a screw is necessarily arranged between adjacent LEDs to attach an LED board including the LEDs to the chassis. Therefore, an interval between the adjacent LEDs with the screw therebetween is relatively larger than intervals between other LEDs, and thus an amount of light entering a light guide plate is partially small in some areas. The areas may be recognized as dark portions.

### DISCLOSURE OF THE PRESENT INVENTION

The present invention was made in view of the above reasons and an object of this invention is to reduce uneven brightness.

### Means for Solving the Problem

A lighting device according to this invention includes a plurality of light sources, a light guide plate, a light source board, a mount member, a board attachment member, and a plurality of arrangement interval variation light sources. The light guide plate includes an end surface and a plate surface. The end surface is opposite the light sources. Light from the light sources enters the light guide plate through the end surface and exits the light guide plate through the plate surface. The light source board is provided with the light sources that are arranged at intervals along the end surface of the light guide plate. The mount member is provided with the light source board mounted thereon. The board attachment member is arranged between the light sources adjacent to each other and attaches the light source board to the mount member. The plurality of arrangement interval variation light sources are included in the light sources and arranged such that the intervals between the arrangement interval variation light sources decrease as a distance from the board attachment member increases.

In this configuration, light emitted from the light sources enters the light guide plate through the end surface and travel within the light guide plate and then exits the light guide plate 19 through the plate surface. The light source board includes the light sources mounted thereto such that the light sources are arranged at intervals along the end surface of the light guide plate. The board attachment member to attach the light source board to the mount member is disposed between the light sources that are adjacent to each other. The interval between the adjacent light sources with board attachment member therebetween tends to be large because a space needs to be provided to arrange the board attachment member. Accordingly, the amount of light entering through the end surface of the light guide plate may be partially small, and this may cause a dark portion. However, as is described above, the light sources include the arrangement interval variation light sources that are arranged such that the intervals therebetween decrease as the distance from the board attachment member increases. Therefore, the amount of light emitted from at least the arrangement interval variation light sources to the end surface of the light guide plate per unit area gradually varies according to the distance from the board attachment member. Accordingly, a dark portion is less likely to be caused at the end surface of the light guide plate, and thus uneven brightness is less likely to occur in the exiting light.

The following configurations are preferable as aspects of this invention.

(1) The arrangement interval variation light sources may include at least a pair of first light sources, a second light source, and a third light source. The pair of first light sources may be arranged with having the board attachment member therebetween. The second light source may be arranged adjacent to at least one of the first light sources such that an interval between the at least one of first light sources and the second light source is smaller than an interval between the pair of first light sources. The third light source may be arranged adjacent to the second light source such that an interval between the second light source and the third light source is smaller than the interval between the at least one of the first light sources and the second light source. In the above configuration, the interval gradually decreases in the following sequence: the interval provided between the first light sources that are arranged with the board attachment member in between, the interval provided between the one of the first light sources and the second light source adjacent to the first light sources, and the interval provided between the second light source and the third light source adjacent to the second light sources. Accordingly, the amount of light entering through the end surface of the light guide plate 19 gradually varies according to the distance from the board attachment member, and thus a dark portion is less likely to occur.

(2) The light reflection portions are configured to reflect light in the light guide plate toward a light exiting side to increase light exiting from the plate surface of the light guide plate and may be arranged such that an area distribution of the light reflection portions in a plane of the plate surface of the light guide plate decreases along an arrangement direction of the light sources as the distance from the board attachment member increases. In the above configuration, the light reflection portions that are configured to reflect light in the light guide plate toward the light exit side are arranged such that the area distribution thereof in the plane of the plate surface of the light guide plate decreases as the distance from the board attachment member along the arrangement direction of the light sources increases. Therefore, light from the light sources that are arranged at the relatively large interval is more likely to be reflected by the light reflection portions, and light from the light sources arranged at the relatively small interval is less likely to be reflected by the light reflection portions. Accordingly, the amount of light exiting from the plate surface of the guide plate is equalized in the plane, and uneven brightness is less likely to occur.

(3) The light sources may further include a plurality of arrangement interval constant light sources that are located further away from the board attachment member than the arrangement interval variation light sources and may be arranged such that the intervals between the arrangement interval constant light sources are constant regardless of the distance from the board attachment member. If the arrangement interval between the light sources is too small, the amount of light entering through the end surface of the light guide plate may partially increase and this may cause a bright portion. However, as described above, the arrangement interval constant light sources, which are located further away from the board attachment member than the arrangement interval variation light sources, are arranged at the constant intervals regardless of the distance from the board attachment member. Therefore, the arrangement interval is less likely to be too small and thus uneven brightness is further less likely to occur.

(4) The arrangement interval variation light sources may be arranged such that the intervals therebetween continuously and gradually decrease as the distance from the board attachment member increases. With the above configuration, the amount of incident light to the end surface of the light guide plate further gradually varies according to the distance from the board attachment member with respect to the arrangement direction of the light sources. Accordingly, dark portions are less likely to occur and thus uneven brightness is further less likely to occur.

(5) The board attachment member may be located at a substantially middle portion of the light source board with respect to an arrangement direction of the light sources. In this configuration in which the board attachment member is arranged in the substantially middle portion of the light source board with respect to the arrangement direction of the light sources, if a dark portion where the amount of light entering through the end surface of the light guide plate is locally small is caused, the dark portion is more likely to be noticeable. However, in this configuration, the arrangement interval variation light sources are arranged such that the intervals therebetween gradually vary according to the distance from the board attachment member. Therefore, the dark portion is less likely to be caused at the middle portion of the light guide plate, and thus uneven brightness is less likely to occur. Further, since the board attachment member is arranged at the substantially middle portion of the light source board, the light source board can extend or shrink according to thermal expansion or thermal contraction. Accordingly, deformation such as warping or deflection is less likely to occur.

(6) One of outer peripheral surfaces of the light guide plate may be a light source opposed surface opposite the light sources and another outer peripheral surface may be a light source non-opposed surface that is not opposite the light sources. In this configuration, only one end surface of the light guide plate among the outer peripheral surfaces thereof is the light source entrance surface and the others are the light source non-opposed surfaces. Therefore, a larger amount of light tends to enter through the light entrance surface compared to a configuration in which two or more end surfaces of a light guide plate are the light entrance surfaces. If a dark portion where the amount of light entering through the end surface of the light guide plate is locally small is caused, the dark portion is more likely to be noticeable. However, in the above embodiment, the arrangement interval variation light sources are arranged such that the intervals therebetween gradually vary according to the distance from the board attachment member. Therefore, the dark portion is less likely to be caused at the middle portion of the light guide late and thus uneven brightness is less likely to occur.

(7) The light sources may be arranged in symmetrical with respect to the board attachment member on the light source board. In this configuration, the light sources are arranged in symmetrical with respect to the board attachment member. Therefore, the amount of light entering through the end surface of the light guide plate symmetrically varies according to the arrangement of the light sources, and thus uneven brightness is less likely to occur.

(8) The lighting device may further include light reflection portions configured to reflect light in the light guide plate toward a light exiting side to increase light exiting from the plate surface of the light guide plate and may be arranged such that an area distribution of the light reflection portions in a plane of the plate surface of the light guide plate decreases along an arrangement direction of the light sources as the distance from the board attachment member increases. The light reflection portions may be symmetrical with respect to the board attachment member along the arrangement direction of the light sources. In this configuration, the light reflection portions, which are configured to reflect light inside the light guide plate toward the light emitting side, are arranged such that the area distribution thereof in the plane of the plate surface of the light guide plate decreases as the distance from the board attachment member increases in the arrangement direction of the light sources. Further, the area distribution of the light reflection portions is symmetric with respect to the board attachment member in the arrangement direction of the light sources. Therefore, light from the light sources that are arranged at the relatively larger interval is more likely to be reflected by the light reflection portions, and light from the light sources that are arranged with the relatively smaller interval therebetween is less likely to be reflected by the light reflection portions. Further, a distribution of an overall amount of the reflected light is symmetrical as described above. Accordingly, light exiting through the plate surface of the light guide plate is further equalized in the plane and thus uneven brightness is further less likely to occur.

(9) A projection height of the board attachment member from the light source board may be smaller than a projection height of the light sources from the light source board. With this configuration, light from the light sources is less likely to be blocked by the board attachment member and uneven brightness is further less likely to occur.

(10) The lighting device may further include a chassis holding the light source board and the light guide plate. The chassis may be the mount member. With this configuration, the light source board can be attached to the mount member with the board attachment member.

Next, to solve the above problem, a display device according to this invention may include the above-described lighting device and a display panel configured to provide display using light from the lighting device.

With this configuration, uneven brightness is less likely to occur in the lighting device that provides light to the display panel. Accordingly, high quality display can be achieved.

The display panel may be a liquid crystal panel. The display device as a liquid crystal display device has a variety of applications, such as a television display or a personal-computer display. In particular, it is suitable for a large screen display.

### Advantageous Effect of the Invention

According to this invention, uneven brightness is reduced.

### BRIEF DESCRIPTION OF THE DRAWINGS

FIG. 1 is an exploded perspective view illustrating a general configuration of a television device according to a first embodiment of this invention.

FIG. 2 is an exploded perspective view illustrating a general configuration of a liquid crystal display device.

FIG. 3 is a cross-sectional view taken along a short-side direction of the liquid crystal display device.

FIG. 4 is a plan view illustrating an arrangement configuration of a chassis, a light guide plate, and an LED board in a backlight unit included the liquid crystal display device.

FIG. 5 is a cross-sectional view taken along line v-v of FIG. 4.

FIG. 6 is a graph indicating variations in an area ratio of dots included in light reflection portions of the light guide plate in an X-axis direction.

FIG. 7 is a graph indicating variations in the area ratio of the dots included in the light reflection portions of the light guide plate in a Y-axis direction.

FIG. 8 is a plan view illustrating an arrangement configuration of a chassis, a light guide plate, and an LED board in a backlight unit according to a second embodiment of this invention.

FIG. 9 is a graph indicating variations in an area ratio of dots included in light reflection portions of a light guide plate in an X-axis direction.

FIG. 10 is a plan view illustrating an arrangement configuration of a chassis, a light guide plate, and an LED board in a backlight unit according to a third embodiment of this invention.

FIG. 11 is a graph indicating variations in an area ratio of dots included in light reflection portions of a light guide plate in an X-axis direction.

FIG. 12 is a plan view illustrating an arrangement configuration of a chassis, a light guide plate, and an LED board in a backlight unit according to a fourth embodiment of this invention.

FIG. 13 is a graph indicating variations in an area ratio of dots included in light reflection portions of a light guide plate in a Y-axis direction.

FIG. 14 is a plan view illustrating an arrangement configuration of a chassis, a light guide plate, and an LED board in a backlight unit according to a fifth embodiment of this invention.

FIG. 15 is a graph indicating variations in an area ratio of dots included in light reflection portions of a light guide plate in a Y-axis direction.

FIG. 16 is a cross-sectional view illustrating a cross-sectional configuration of a chassis, an LED board, and a clip member according to a sixth embodiment of this invention.

FIG. 17 is an exploded perspective view illustrating a general configuration of a television device and a liquid crystal display device according to a seventh embodiment of this invention.

FIG. 18 is an exploded perspective view illustrating a general configuration of a liquid crystal display unit of a liquid crystal display device.

FIG. 19 is a cross-sectional view taken along a short-side direction of a liquid crystal display device.

FIG. 20 is a plan view illustrating an arrangement configuration of a chassis, a light guide plate, and an LED board in a backlight unit according to an eighth embodiment of this invention.

FIG. 21 is a cross-sectional view illustrating a cross-sectional configuration of a chassis, and LED board, and a screw member according to a ninth embodiment of this invention.

### MODE FOR CARRYING OUT THE INVENTION

### First Embodiment

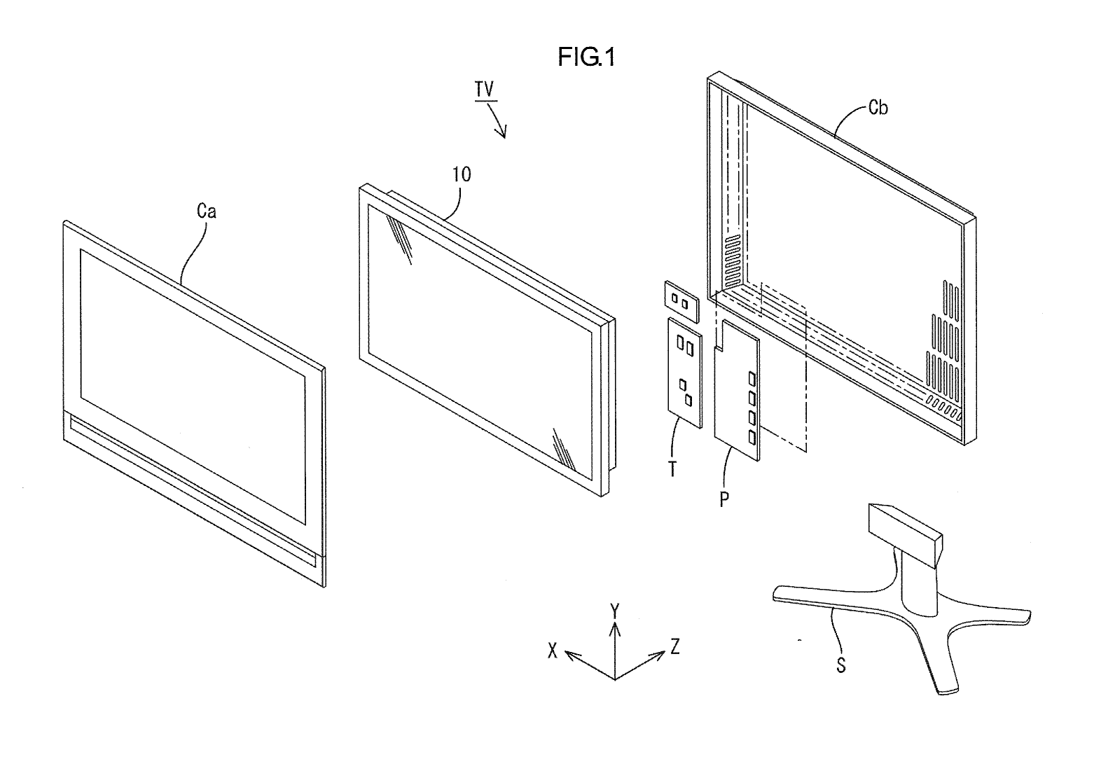

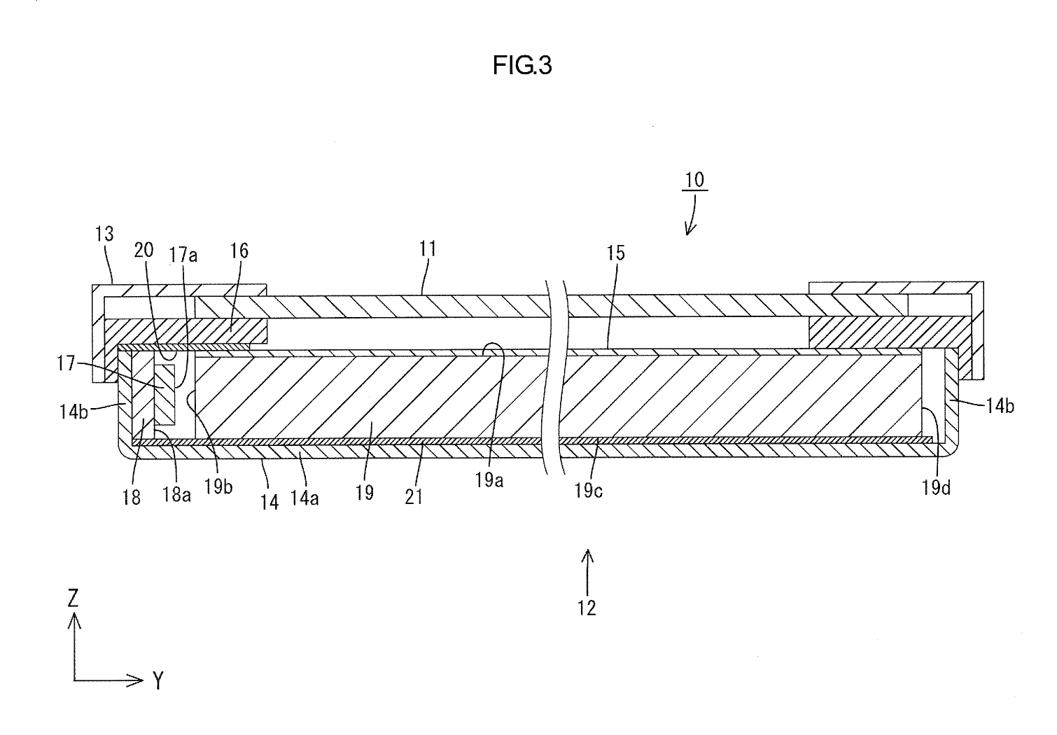

A first embodiment of this invention will be described with reference to FIGS. 1 to 7. According to this embodiment, a liquid crystal display device 10 will be described. An X-axis, a Y-axis and a Z-axis are present in some drawings. The axes in each drawing correspond to the respective axes in other drawings. An upper side and a lower side in FIG. 3 correspond to a front side and a rear side, respectively.

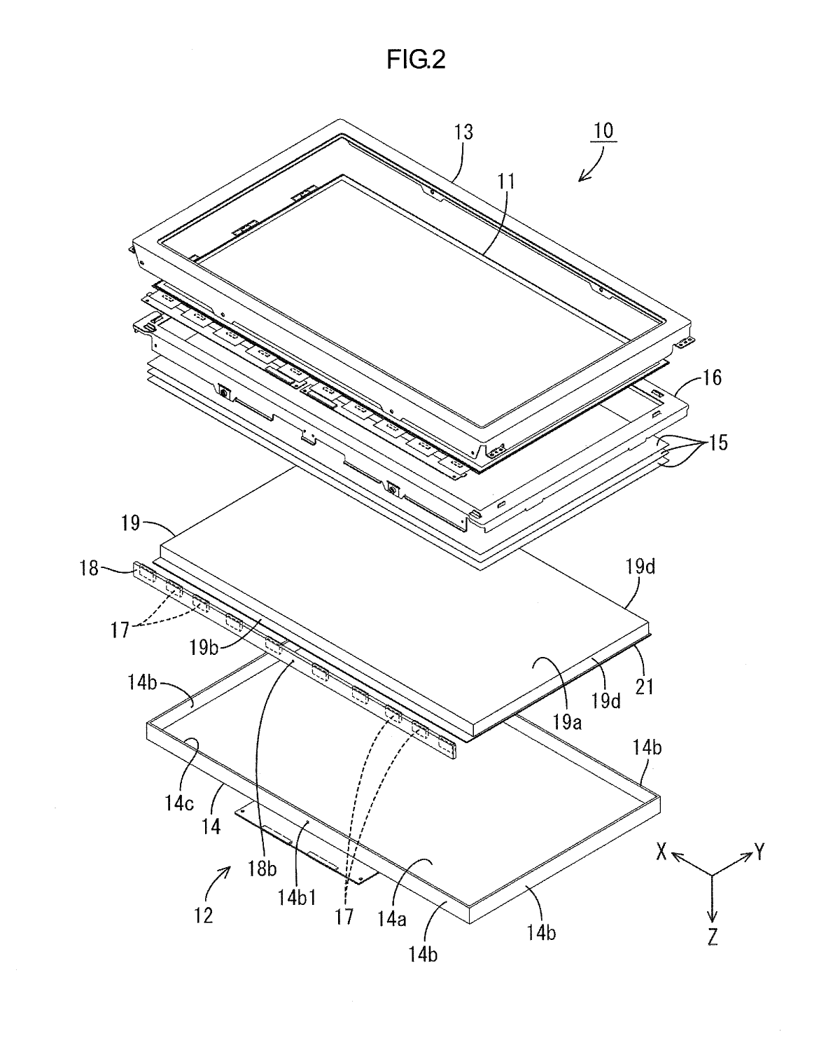

As illustrated in FIG. 1, a television device TV according to this embodiment includes the liquid crystal display device 10, front and rear cabinets Ca and Cb that hold the liquid crystal display device 10 therebetween, a power source P, a tuner T, and a stand S. An overall shape of the liquid crystal display device (a display device) 10 is a landscape rectangular (longitudinal). The liquid crystal display device 10 is held in a vertical position. As illustrated in FIG. 2, the liquid crystal display device 10 includes a liquid crystal panel 11 as a display panel and a backlight unit (a lighting device) 12. The liquid crystal panel 11 and the backlight unit 12 are held with a bezel 13 having a frame-like shape.

As illustrated in FIG. 2, the liquid crystal panel has a landscape rectangular shape (rectangular and longitudinal) in a plan view and includes a pair of glass substrates and liquid crystals. The substrates having high light transmissivity are bonded together with a predetermined gap therebetween. The liquid crystals are sealed between the substrates. On one of the substrates (an array substrate), switching components (e.g., TFTs), pixel electrodes and an alignment film are arranged. The switching components are connected to source lines and gate lines that are perpendicular to each other. The pixel electrodes are connected to the switching components. On the other substrate (a CF substrate), a color filter, common electrodes, and an alignment film are arranged. The color filter has color sections such as R (red), G (green) and B (blue) color sections that are arranged in a predetermined pattern. The liquid crustal panel 11 includes a display area and a non-display area. The display area is an inner area of a screen in which images are displayed. The non-display area is an outer area of the screen around the display area and has a frame-like shape. Polarizing plates are arranged on outer sides of the substrates.

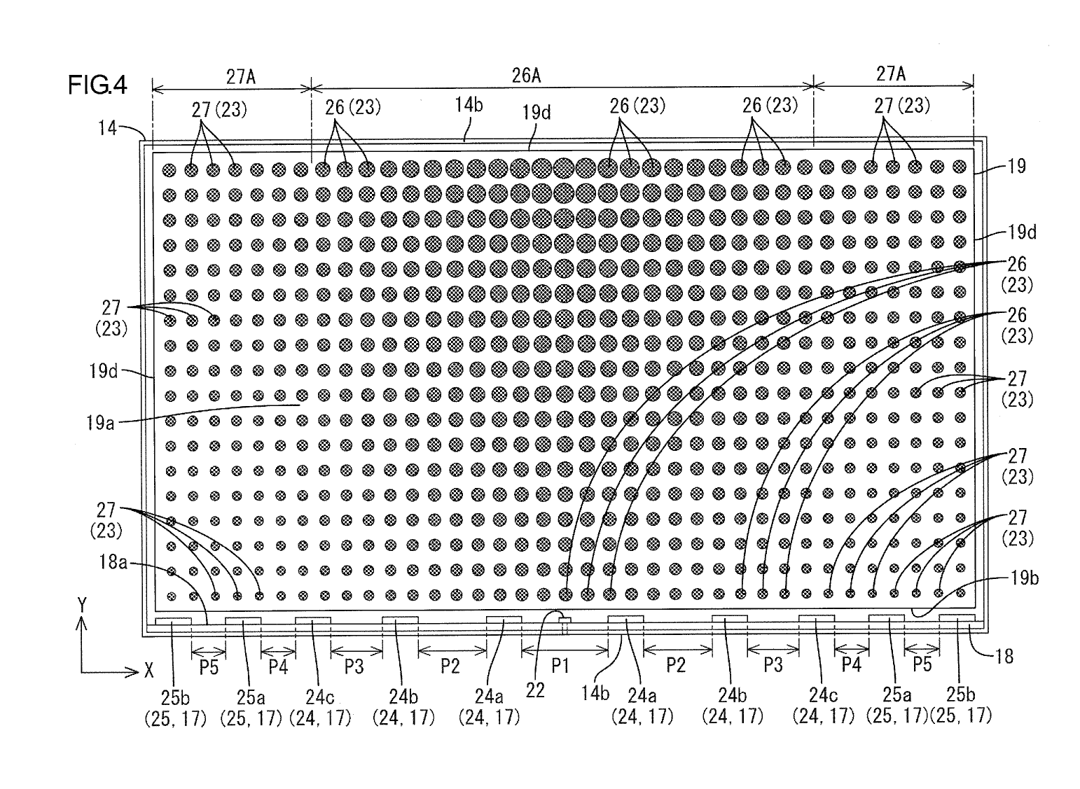

As illustrated in FIG. 2, the backlight unit 12 includes a chassis 14 and optical members 15. The chassis 14 having a substantially tray-like shape includes a light exit portion 14c that opens to the front side (a light exit side, a liquid crystal panel 11 side). The optical members 15 cover the light exit portion 14c. The chassis 14 holds LEDs (Light Emitting Diodes) 17 provided as light sources, an LED board (light source board) 18 on which the LEDs 17 are mounted, a light guide plate 19, a frame (a holding member) 16, and a screw member (a board attachment member) 22. The light guide plate 19 is configured to guide light from the LEDs 17 toward the optical members 15 (toward the liquid crystal panel 11). The frame 16 presses the light guide plate 19 and the optical members 15 from the front side. The screw member 22 fixes the LED board 18 to the chassis (a mount member) 14. The LED board 18 is arranged at one of long-side end portions (on a front side in FIGS. 2 and 4 or a left side in FIG. 3) of the backlight unit 12, and accordingly, the LEDs 17 mounted on the LED board 18 are located locally close to one of long-side end portions of the liquid crystal panel 11. The backlight unit 12 according to this embodiment is so-called a single-edge-light type (or a side-light type) backlight in which light enters the light guide plate 19 only through one side of the light guide plate 19. Hereinafter, components of the backlight unit 12 will be described in detail.

The chassis 14 is made of a metal plate such as an aluminum plate and an electrolytic zinc-coated steel sheet (SECC). As illustrated in FIGS. 2 and 4, similar to the liquid crystal panel 11, the chassis 14 has a landscape rectangular shape in a plan view. A long-side direction and a short-side direction of the chassis 14 correspond to the X-axis direction (the horizontal direction) and the Y-axis direction (the vertical direction), respectively. The chassis 14 includes a bottom plate 14a having a landscape rectangular shape and side plates 14b extending from long-side and short-side ends of the bottom plate 14a. The LED board 18 is attached to one of the side plates 14b on the long side (on the front side in FIGS. 2 and 4 or on the left side in FIG. 3) of the chassis 14. The frame 16 and the bezel 13 can be fixed to the side plates 14b with screws.

As illustrated in FIG. 2, similar to the liquid crystal panel 11 and the chassis 14, the optical members 15 have a landscape rectangular shape in a plan view. The optical members 15 are placed on a front surface (a light exit side surface) of the light guide plate 19 and located between the liquid crystal panel 11 and the light guide plate 19. Light receives predetermined optical effects while passing through the optical members 15 and exits toward the liquid crystal panel 11. The optical members 15 include multiple sheet-like members (three sheets in this embodiment) which are overlaid with each other. Each optical member 15 may be selected from a diffuser sheet, a lens sheet, and a reflecting type polarizing sheet, whatever is appropriate. In FIG. 3, the optical members 15 including three sheets are simplified and illustrated as one sheet.

As illustrated in FIG. 2, the frame 16 has a frame shape extending along outer edge portions of the light guide plate 19 and holds down substantially the entire edge portions of the light guide plate 19 from the front side. The frame 16 is made of synthetic resin. A front surface of the frame 16 may be in black so as to have light blocking properties. As illustrated in FIG. 3, a first reflection sheet 20 that reflects light are attached on an inner surface of one of long-side portions of the frame 16 opposite the LED board 18 (the LEDs 17). The first reflection sheet 20 extends over substantially an entire length of the long-side portion of the frame 16. The first reflection sheet 20 covers an end portion of the light guide plate 19 on an LED 17 side and the LED board 18 from the front side. The frame 16 receives outer edge portions of the liquid crystal panel 11 from the rear side.

As illustrated in FIGS. 3 and 4, each of the LEDs 17 includes an LED chip that is arranged on a board fixed on the LED board 18 and sealed with resin. The LED chip mounted on the board has one main light emission wavelength. Specifically, the LED chip that emits light in a single color of blue is used. The resin that reals the LED chip contains phosphors dispersed therein. The phosphors emit light in a predetermined color when excited by blue light emitted from the LED chip. Overall color of light emitted from the LED 17 is white. The phosphors may be selected, as appropriate, from yellow phosphors that emit yellow light, green phosphors that emit green light, and red phosphors that emit red light. The phosphors may be used in combination of the above phosphors. The LED 17 includes a main light-emitting surface 17a that is opposite from a mount surface of the LED 17 on which the LED board 18 is mounted. Namely, the LED 17 is a top-surface-emitting type LED.

As illustrated in FIGS. 2 and 4, the LED board 18 has an elongated plate-like shape extending in the long-side direction (the X-axis direction, a long-side direction of a light entrance surface 19b of the light guide plate 19) of the chassis 14. The LED board 18 is arranged in the chassis 14 such that plate surfaces of the LED board 18 are parallel to the X-Z plane, i.e., perpendicular to plate surfaces of the liquid crystal panel 11 and the light guide plate 19 (the optical members 15). Namely, the long-side direction (a length direction) and the short-side direction (a width direction) of the plate surfaces of the LED board 18 correspond to the X-axis direction and the Z-axis direction, respectively. A plate-thickness direction of the LED board 18 perpendicular to the plate surfaces thereof corresponds to the Y-axis direction. The board of the LED board 18 may be formed of a synthetic resin (a phenolic paper or a glass epoxy resin, for example).

As illustrated in FIGS. 3 and 4, the LED board 18 includes a mount surface 18a on which the LEDs 17 are surface-mounted. The mount surface 18a is one of the plate surfaces that faces an inner side, namely, a surface of the LED board 18 that faces the light guide plate 19 (a surface opposite the light guide plate 19). The LEDs 17 are arranged apart from each other in a line (i.e., linearly) on the mount surface 18a of the LED board 18 along the long-side direction of the LED board 18 (the X-axis direction). Specifically, ten LEDs 17 are arranged at predetermined intervals. In other words, multiple LEDs 17 are arranged at intervals in each of the long-side end portions of the backlight unit 12 along the long-side direction. An arrangement direction of the LEDs 17 corresponds to the length direction of the LED board 18 (the X-axis direction). The arrangement of the LEDs 17 will be described later. A metal-film trace (not illustrated), such as a copper-foil trace, is formed on the mount surface 18a of each LED board 18. The metal-film trace extends in the X-axis direction and crosses over a group of the LEDs 17 so as to connect the adjacent LEDs 17 in series. Terminals at ends of the trace are connected to an external LED drive board (not illustrated), and driving power is supplied to the LEDs 17 therethrough.

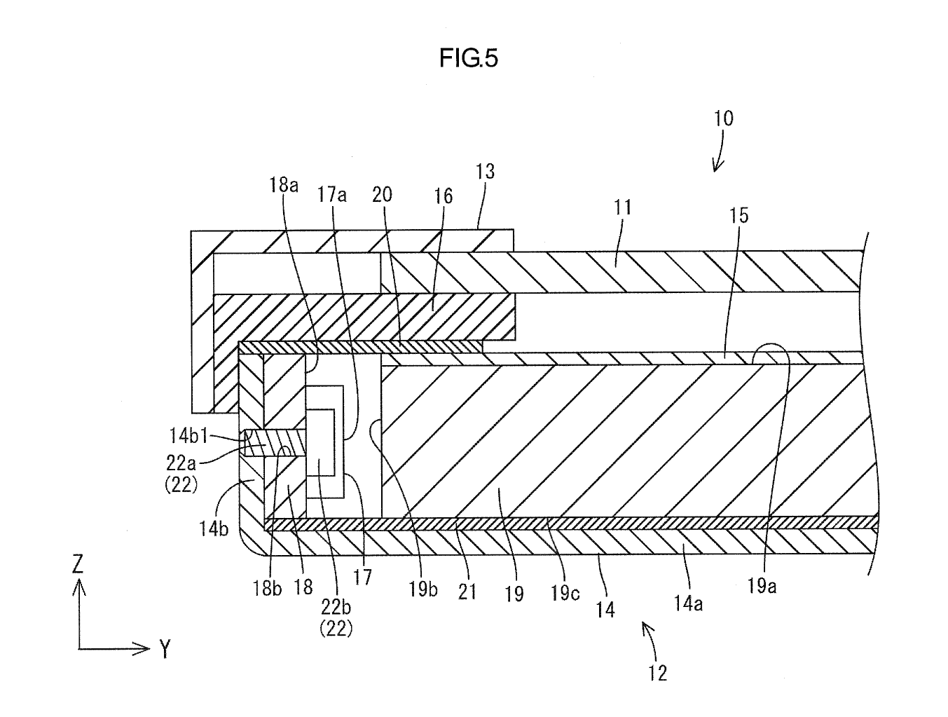

As illustrated in FIGS. 4 and 5, the LED board 18 and the chassis 14 are fixed to each other with a screw member 22 such that a plate surface of the LED board 18 on an outer side (a side opposite to the mount surface 18a on which the LEDs 17 are mounted) is in contact with an inner surface of one of the side plates 14b that is on the long side of the chassis 14. The LED board 18 includes a screw through hole (a board attachment member through hole) 18b in a substantially middle portion of the LED board 18 with respect to the length direction (the X-axis direction). The screw member 22 is inserted through the screw through hole 18b. The screw through hole 18b is formed in the substantially middle portion of the LED board 18 with respect to the width direction (the Y-axis direction) of the LED board 18, and disposed apart from the trace. The long-side side plate 14b of the chassis 14 to which the LED board 18 is attached includes a screw attachment hole (a board attachment member attachment hole) 14b1. The screw attachment hole 14b1 is formed through a substantially middle portion of the side plate 14b with respect to the length direction so as to communicate with the screw through hole 18b. The screw member 22 that is screwed into the screw through hole 18b is further screwed into the screw attachment hole 14b1. The screw member 22 includes a shaft portion 22a and a head portion 22b. The shaft portion 22a having a substantially post shape includes a screw thread that is formed on an outer peripheral surface of the shaft portion 22a. The head portion 22b having a substantially disk-like shape continues to one of end portions of the shaft portion 22a. The screw thread of the shaft portion 22a is screwed into the screw attachment hole 14b1 of the side plate 14b of the chassis 14, and thus the head portion 22b and the side plate 14b can hold the LED board 18 therebetween. A projection height (a thickness dimension of the heat portion 22b) of the screw member 22 from the mount surface 18a of the LED board 18 is smaller than a protrusion height (a distance from the mount surface 18a to the main light-emitting surface 17a) of the LED 17 from the mount surface 18a of the LED board 18. Therefore, light exiting from the LED 17 through the main light-emitting surface 17a is less likely to be blocked by the screw member 22. As described above, the LED board 18, which is attached to the long-side side plate 14b of the chassis 14, is located on the left side in FIG. 3 with a predetermined space apart from a long-side end portion of the light guide plate 19. An arrangement direction in which the LEDs 17 and the LED board 18 and the light guide plate 19 are arranged substantially corresponds to the Y-axis direction. Accordingly, a light axis of each LED 17, that is, a traveling direction of rays of light having the highest light intensity substantially corresponds to the Y-axis direction (a direction along the plate surface of the liquid crystal panel 11).

The light guide plate 19 is made of substantially transparent (high transmissivity) synthetic resin (e.g. acrylic resin or polycarbonate such as PMMA) that has a refractive index sufficiently higher than that of the air. As illustrated in FIG. 2, the light guide plate 19 has a landscape rectangular shape in a plan view similar to the liquid crystal panel 11 and the chassis 14. The light guide plate 19 is a plate member having a thickness that is larger than that of the optical members 15. A long-side direction and a short-side direction of the plate surfaces of the light guide plate 19 correspond to the X-axis direction and the Y-axis direction, respectively. A thickness direction of the light guide plate 19 that is perpendicular to the plate surfaces of the light guide plate 19 corresponds to the Z-axis direction. As illustrated in FIG. 3, the light guide plate 19 is arranged right behind the liquid crystal panel 11 and the optical members 15 in the chassis 14. The light guide plate 19 includes long-side end surfaces included in outer peripheral end surfaces thereof. One of the long-side end surfaces (the front side in FIGS. 2 and 4 or the left side in FIG. 3) of the light guide plate 19 is opposite the LEDs 17 of the LED board 18 that are arranged in one of the long-side end portions of the chassis 14. Namely, an arrangement direction between the LEDs 17 (or the LED board 18) and the light guide plate 19 corresponds to the Y-axis direction, and an arrangement direction between the optical members 15 (or the liquid crystal panel 11) and the light guide plate 19 corresponds to the Z-axis direction. The both arrangement directions are perpendicular to each other. The light guide plate 19 is configured to guide the light, which is emitted from the LEDs 17 in the Y-axis direction and enters the light guide plate 19, toward the optical members 15 (on the front side).

As illustrated in FIGS. 2 and 4, the light guide plate 19 has a plate-like shape extending along plate surfaces of the bottom plate 14a of the chassis 14 and the optical members 15. The plate surfaces of the light guide plate 19 are parallel to the X-Y plane. One of the plate surfaces (a surface opposite the optical members 15) of the light guide plate 19 on the front side is a light exit surface 19a. Light that is inside the light guide plate 19 exits through the light exit surface 19a toward the optical members 15 and the liquid crystal panel 11. The outer peripheral end surfaces of the light guide plate 19 that are adjacent to the plate surfaces thereof include the long-side end surfaces elongated along the X-axis direction (the arrangement direction of the LEDs 17 or the long-side direction of the LED board 18). One of the long-side end surfaces (located on the front side in the FIGS. 2 and 4) is opposite the LEDs 17 (or the LED board 18) with a predetermined space therebetween and is the light entrance surface 19b through which light emitted from the LEDs 17 enters the light guide plate 19. Since the light entrance surface 19b is opposite the LEDs 17, the light entrance surface 19b is referred to as an LED opposed surface (a light source opposed surface). On the other hand, among the outer peripheral end surfaces of the light guide plate 19 that are adjacent to the plate surfaces of the light guide plate 19, three surfaces except the above-described light entrance surface 19b (another long-side surface (located on a far end side in FIGS. 2 and 4) and short-side end surfaces) are LED non-opposed surfaces (light source non-opposed surfaces) 19d that are not opposite the LEDs 17. A distance between the light entrance surface 19b and each opposed LED 17 is substantially the same. The light entrance surface 19b is parallel to the X-axis direction (the arrangement direction of the LEDs 17) and the Z-axis direction. In other words, the light entrance surface 19b is parallel to the plate surfaces of the LED board 18, and substantially perpendicular to the light exit surface 19a. An arrangement direction between the LEDs 17 and the light entrance surface 19b corresponds to the Y-axis direction, and parallel to the light exit surface 19a.

As illustrated FIG. 3, a second reflection sheet 21 is disposed on the rear surface of the light guide plate 19, that is, a plate surface (a surface opposite to the bottom plate 14a of the chassis 14) 19c away from the light exit surface 19a of the light guide plate 19 so as to cover about the entire surface. The second reflection sheet 21 is configured such that light exiting the light guide plate 19 through the plate surface 19c toward the rear side is reflected thereby toward the front side. The second reflection sheet 21 is sandwiched between the bottom plate 14a of the chassis 14 and the light guide plate 19. An end portion of the second reflection sheet 21 on a light entrance surface 19b side of the light guide plate 19 extends outward from the light entrance surface 19b of the light guide plate 19, that is, toward an LEDs 17 side. An extended end portion of the second reflection sheet 21 faces the first reflection sheet 20 that is attached to the frame 16. The LEDs 17 and the light entrance surface 19b define a space in between, and the space is positioned between the first reflection sheet 20 and the second reflection sheet 21. Therefore, light that travels from the LEDs 17 toward the light entrance surface 19b is repeatedly reflected by the first reflection sheet 20 and the second reflection sheet 21, and thus the light efficiently enters the light guide plate 19. On the plate surface 19c of the light guide plate 19 that is opposite to the light exit surface 19a, light reflection portions 23 are provided. The light reflection portions 23 are for reflecting rays of light inside the light guide plate 19 toward the light exit surface 19a to increase the rays of light exiting through the light exit surface 19a. The light reflection portions 23 are located between the plate surface 19c of the light guide plate 19 that is opposite to the light exit surface 19a and the second reflection sheet 21.

As illustrated in FIG. 4, the light reflection portions 23 are formed by printing a light reflective material on the plate surface 19c of the light guide plate 19 away from the light exit surface 19a. Namely, the light reflection portions 23 may be referred to as light reflective prints. The light reflective material used for the light reflection portions 23 is a white ink (or a paste) containing metal oxide such as titanium oxide. The light reflection portions 23 are configured to diffusely reflect the rays of light entering the light guide plate 19 and reaching the plate surface 19c away from the light exit surface 19a toward the light exit surface 19a. The light reflection portions 23 are further configured to vary an angle of incidence at the light exit surface 19a compared with an angle of incidence of light that is fully reflected at the light exit surface 19a. With this configuration, more rays of light, the angles of incidence of which do not exceed the critical angle exist and thus the amount of light that exits through the light exit surface 19a increases. The light reflection portions 23 may be formed on the light guide plate 19 by printing methods including silk printing (screen printing) and inkjet printing. With the silk printing, production cost is reduced when the light guide plates 19 are mass-produced. With the inkjet printing, the light reflection portions 23 can be formed with high accuracy even if the light reflection portions 23 are formed in a complex pattern.

The backlight unit 12 according to this embodiment is an edge-light type backlight unit in which the LEDs 17 are locally arranged in one end portion of the chassis 14. As illustrated in FIGS. 4 and 5, the screw member 22 that fixes the LED board 18 including the LEDs 17 to the chassis 14 is arranged between the adjacent LEDs 17 on the LED board 18. In this configuration, a space for the screw member 22 provided between the adjacent LEDs 17 is likely to increase an interval (an arrangement interval) between the adjacent LEDs 17 arranged with the screw member 22 in between. If only the interval between specific LEDs is large, an amount of light entering the light guide plate through a part of the light entrance surface opposed to the specific LEDs is locally small, and this may cause a dark portion. According to this embodiment, as illustrated in FIG. 4, the LEDs 17 arranged in a line at intervals on the LED board 18 include arrangement interval variation LEDs (arrangement interval variation light sources) 24. The arrangement interval variation LEDs 24 are arranged such that intervals P1 to P3 therebetween decrease as a distance from the screw member 22 increases. Since the LEDs 17 include the arrangement interval variation LEDs 24, the intervals P1 to P3 between the adjacent LEDs 17 gradually vary according to the distance from the screw member 22. Accordingly, an amount of light entering through the light entrance surface 19b gradually varies according to the distance from the screw member 22. Therefore, the above-described dark portion is less likely to be caused. Next, the intervals between the LEDs 17 will be described in detail.

As illustrated in FIG. 4, the arrangement interval variation LEDs 24 include a total of six LEDs that are a pair of first LEDs (first light sources) 24a, a pair of second LEDs (second light sources) 24b, and a pair of third LEDs (third light sources) 24c. The first LEDs 24a are arranged adjacent to each other with the screw member 22 in between. The screw member 22 is located in the substantially middle portion of the LED board 18 with respect to the length direction (the X-axis direction or the arrangement direction of the LEDs 17). Each of the second LEDs 24b is on an outer side (a side opposite to a screw member 22 side) with respect to and adjacent to the corresponding first LED 24a. Each of the third LEDs 24c is on an outer side (the side opposite to the screw member 22 side or a side opposite to a first LED 24a side) with respect to and adjacent to the corresponding second LED 24b. Among the LEDs 17, the first LEDs 24a are located at the shortest distance from the screw member 22 on the LED board 18 in the X-axis direction. In other words, the first LEDs 24a are located closest to the middle portion of the LED board 18 with respect to the length direction of the LED board 18. A distance from the screw member 22 (the middle portion of the LED board 18 in the length direction) to the second LED 24b and the third LED 24c in the X-axis direction increases in this sequence. The third LEDs 24c are arranged closest to respective ends of the LED board 18 among the arrangement interval variation LEDs 24. Herein, when “P1” denotes the interval between the pair of first LEDs 24a, “P2” denotes the interval between the first LED 24a and the second LED 24b, and “P3” denotes the interval between the second LED 24b and the third LED 24c, the size relation thereof satisfies an inequality of “P1>P2>P3”. P1 has a maximum value and P3 has a minimum value. Specifically, a dimension of P1 is about 5 mm, a dimension of P2 is about 4 mm, and a dimension of P3 is about 3 mm. As is just described, the arrangement interval variation LEDs 24 are arranged on the LED board 18 such that the intervals P1 to P3 therebetween gradually decrease as the distance from the screw member 22 increases in the X-axis direction (the arrangement direction of LEDs 17). The first LEDs 24a, the second LEDs 24b, and the third LEDs 24c are arranged in symmetrical with respect to a symmetry line that passes through the middle portion (or the screw member 22) of the LED 18 in the length direction.

As illustrated in FIG. 4, the LEDs 17 according to this embodiment include arrangement interval constant LEDs (arrangement interval constant light sources) 25. The arrangement interval constant LEDs 25 are located further away from the screw member 22 than the arrangement interval variation LEDs 24. The arrangement interval constant LEDs 25 are arranged such that an interval P4 and P5 therebetween is substantially constant regardless of the distance from the screw member 22. The arrangement interval constant LEDs 25 include a total of four LEDs that are a pair of fourth LEDs (fourth light sources) 25a and a pair of fifth LEDs (fifth light sources) 25b. Each of the fourth LEDs 25a is on an outer side (a side opposite to the screw member 22 side or a side opposite to a second LED 24b side) with respect to and adjacent to the corresponding third LED 24c that is the arrangement interval variation LED 24. Each of the fifth LEDs 25b is on an outer side (a side opposite to the screw member 22 side or opposite to a third LED 24c side) with respect to and adjacent to the corresponding fourth LED 25a. The distance in the X-axis direction from the fifth LED 25b to the screw member 22 (the middle portion of the LED board 18 in the length direction) is longer than the distance from the fourth LED 25a to the screw member 22 on the LED board 18. The fourth LEDs 25a are located relatively close to the middle portion (close to the screw member 22) of the LED board 18 among the arrangement interval constant LEDs 25. The fifth LEDs 25b are arranged closest to respective ends of the LED board 18 among all the LEDs 17. Herein, when “P4” denotes the interval between the third LED 24c and the fourth LED 25a and “P5” denotes the interval between the fourth LED 25a and the fifth LED 25b, an equality of “P4=P5” is satisfied while an inequality of “P3>P4=P5” is satisfied. Accordingly, among all of the LEDs 17 (the arrangement interval variation LEDs 24 and the arrangement interval constant LEDs 25), the arrangement interval takes a maximum value at “P1” and takes a minimum value at “P4 and P5”. Specifically, a dimension of P4 and a dimension of P5 are about 2 mm and substantially equal. As is just described, the arrangement interval constant LEDs 25 are arranged on the LED board 18 such that the intervals P4 and P5 therebetween are substantially equal (less likely to vary) regardless of the distance from the screw member 22. The fourth LEDs 25a and the fifth LEDs 25b are arranged in symmetrical with respect to the symmetry line that passes through the middle portion (or the screw member 22) of the LED board 18 in its length direction.

According to the arrangement of the LEDs 17 as described above, the light reflection portions 23 for directing more light to the outside of the light guide plate 19 have following configurations. As illustrated in FIG. 4, the light reflection portions 23 include a number of dots formed with ink and dispersedly arranged with predetermined distribution within the plate surface 19c opposite from the light exiting surface 19a of the light guide plate 19. The dots include area variation dots 26 that are arranged such that an area of the dots 26 decreases as the distance from the screw member 22 in the X-axis direction increases in the area distribution of the dots 26 within a plane of the plate surface (the light exit surface 19a, the plate surface 19c) of the light guide plate 19. Further, in addition to the area variation dots 26, the dots included in the light reflection portions 23 include area constant dots 27. The area constant dots 27 are arranged such that an area of the dots 27 is constant regardless of the distance from the screw member 22 in the X-axis direction in the area distribution of the dots 27 within the plane of the plate surface of the light guide plate 19. The area variation dots 26 and the area constant dots 27 will be described in detail next.

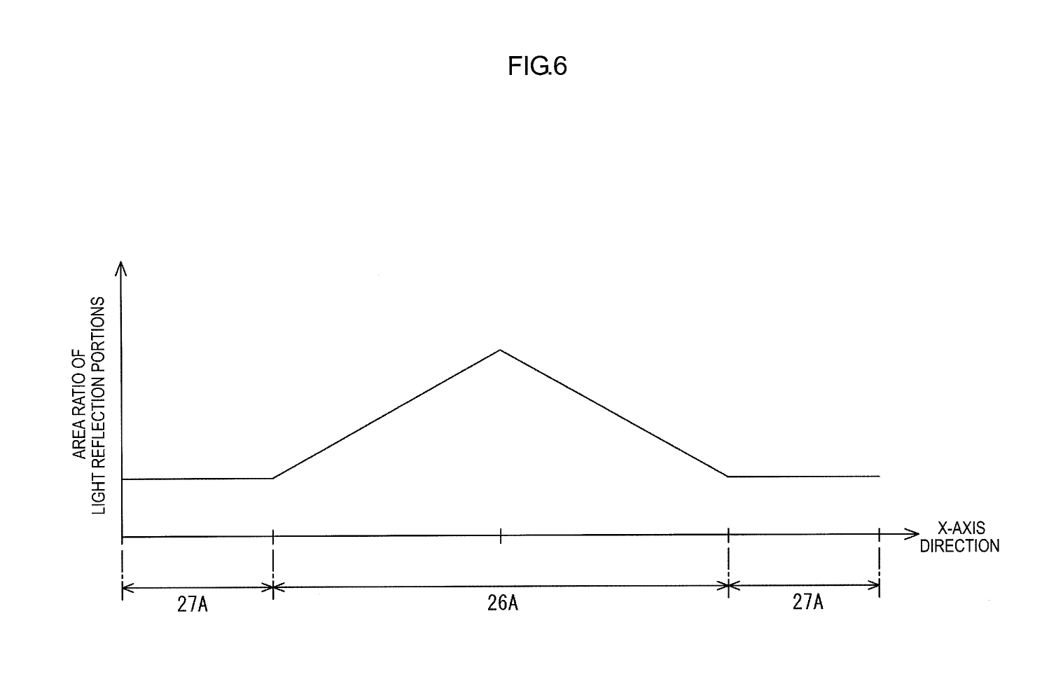

As illustrated in FIGS. 4 and 6, the area variation dots 26 are arranged in a middle portion of the plate surface of the light guide plate 19 with respect to the long-side direction (the X-axis direction) of the light guide plate 19, and not arranged in end portions thereof. The area variation dots 26 are patterned as follows. An area ratio of the area variation dots 26 per unit area in the plane of the plate surface (the light exit surface 19a, the plate surface 19c) of the light guide plate 19 takes a maximum value in the middle portion of the light guide plate 19 with respect to the X-axis direction (the arrangement direction of the LEDs 17), that is, a portion of the light guide plate 19 corresponding to the screw member 22 with respect to the X-axis direction. The area ratio of the area variation dots 26 gradually decreases as a distance from the middle portion of the light guide plate 19 toward edges of the light guide plate 19 in the X-axis direction increases. The area ratio takes a minimum value at a portion of the light guide plate 19 corresponding to the third LED 24c of the arrangement interval variation LEDs 24 in the X-axis direction. In other words, an arrangement region 26A of the light guide plate 19 including the area variation dots 26 substantially corresponds to an arrangement region of the LED board 18 including the arrangement interval variation LEDs 24 (the first LEDs 24a, the second LEDs 24b, and third LEDs 24c). The areas of the area variation dots 26 continuously and gradually decrease as the distance from the screw member 22 in the X-axis direction increases.

The first LEDs 24a are arranged at the relatively large interval P1, and rays of light emitted from the first LEDs 24a and entering the light guide plate 19 through the light entrance surface 19b are more likely to be reflected by dots having relatively large areas among the area variation dots 26. On the other hand, the third LED 24c is arranged with the relatively small interval P3, and rays of light emitted from the third LED 24c and entering the light guide plate 19 through the light entrance surface 19b are less likely to be reflected by dots having relatively small areas among the area variation dots 26. Accordingly, in the light exit surface 19a of the light guide plate 19, the amount of light exiting the arrangement region 26A including the area variation dots 26 is equalized in the plane.

As illustrated in FIGS. 4 and 6, the area constant dots 27 are arranged in the end portions of the plate surface of the light guide plate 19 with respect to the long-side direction (the X-axis direction) and not arranged in the middle portion thereof. The area constant dots 27 are patterned as follows. An area ratio of the area constant dots 27 per unit area in the plane of the plate surface (the light exit surface 19a, the plate surface 19c) of the light guide plate 19 is substantially constant regardless of the positions in the X-axis direction (the arrangement direction of the LEDs 17), that is, regardless of the distance from the screw member 22 in the X-axis direction. The area ratio of the area constant dots 27 takes the minimum value in the plane of the plate surface of the light guide plate 19. The area constant dots 27 are arranged so as to correspond to the fourth LEDs 25a and the fifth LEDs 25b included in the arrangement interval constant LEDs 25 with respect to the X-axis direction. In other words, an arrangement region 27A of the light guide plate 19 including the area constant dots 27 substantially corresponds to an arrangement region of the LED board 18 including the arrangement interval constant LEDs 25 (the fourth LEDs 25a and the fifth LEDs 25b). Rays of light emitted from the fourth LED 25a and the fifth LED 25b, which are included in the arrangement interval constant LEDs 25, and entering the light guide plate 19 through the light entrance surface 19b are reflected by the area constant dots 27. Accordingly, in the light exit surface 19a of the light guide plate 19, the amount of light exiting the arrangement region 27A including the area constant dots 27 is equalized in the plane. The area variation dots 26 and the area constant dots 27 included in the light reflection portion 23 are arranged such that their area distributions are symmetric with respect to a symmetry line passing through the middle portion of the light guide plate 19 with respect to the long-side direction thereof. The area distributions of the area variation dots 26 and the area constant dots 27 are similar to the area distributions of the arrangement interval variation LEDs 24 and the arrangement interval constant LEDs 25 included in the LEDs 17 in the LED board 18.

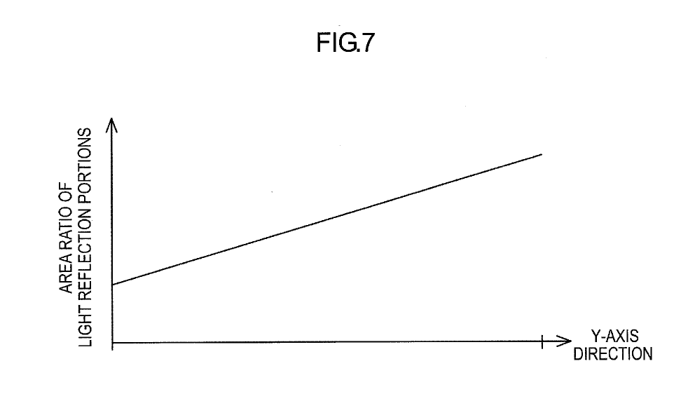

Next, the area distribution of the light reflection portions 23 in the short-side direction (the Y-axis direction) of the light guide plate 19 will be described. As illustrated in FIGS. 4 and 7, an area ratio of the light reflection portions 23 per unit area in the plane of the plate surface of the light guide plate 19 continuously and gradually decreases as a distance from the LEDs 17 (or the light entrance surface 19b) in the Y-axis direction increases, and continuously and gradually increases as the distance from the LEDs 17 decreases. A left end of the horizontal axis in FIG. 7 corresponds to the end portion of the light guide plate 19 on the light entrance surface 19b side. A right end of the horizontal axis in FIG. 7 corresponds to the other end of the light guide plate 19 opposite to the light entrance surface 19b. Areas of the area constant dots 27 are “constant” only when areas of the dots arranged along the X-axis direction are compared. However, when areas of the dots arranged along the Y-axis direction are compared, the areas continuously and gradually decrease as the distance from the LEDs 17 increases. This configuration is the same for the area variation dots 26.

This embodiment has the above-described configuration, and an operation thereof will be described. When the liquid crystal display device 10 having the above-described configuration is tuned on, driving of the liquid crystal panel 11 is controlled by a panel control circuit (not illustrated), and driving of the LED 17 on the LED board 18 is controlled by driving power provided from an LED drive circuit (not illustrated). Light emitted from each LED 17 is guided by the light guide plate 19 and applied to the liquid crystal panel 11 via the optical members 15. As a result, images are displayed on the liquid crystal panel 11. Hereinafter, operations of the backlight unit 12 will be explained.

As illustrated in FIG. 3, when the LED 17 is turned on, the rays of light emitted from the LED 17 enter the light guide plate 19 through the light entrance surface 19b. The LED 17 and the light entrance surface 19b are arranged with a predetermined space therebetween. The space is provided between the first reflection sheet 20 on the front side and the extended end portion of the second reflection sheet 21 on the rear side. Therefore, the rays of light from the LED 17 are repeatedly reflected by the both reflection sheets 20 and 21 and thus the rays of light efficiently enter through the light entrance surface 19b. The rays of light that enter through the light entrance surface 19b are totally reflected by an interface between the light guide plate 19 and an external air layer or by the second reflection sheet 21. Furthermore, the rays of light are diffusely reflected by the light reflection portions 23 while traveling through the light guide plate 19. With this configuration, the incident angles of the rays of light to the light exit surface 19a do not exceed the critical angle and thus more rays of light exit from the light exit surface 19a.

As illustrated in FIG. 4, the LED board 18 on which the LEDs 17 are mounted is attached to the chassis 14 with the screw member 22. The screw member 22 is located at the middle portion of the LED board 18 with respect to the long-side direction of the LED board 18. Because the screw 22 is arranged between the adjacent LEDs 17, the interval P1 between the adjacent LEDs 17 (the first LEDs 24a) tends to be large. This may cause a partial dark portion in the light entrance surface 19b through which light from the LEDs 17 (the first LEDs 24a) enters the light guide plate 19. However, in this embodiment, the LEDs 17 include the arrangement interval variation LEDs 24, which are arranged such that the intervals P1 to P3 therebetween decrease as the distance from the screw member 22 increases. Therefore, the amount of light emitted from at least the arrangement interval variation LEDs 24 and entering the light guide plate 19 through the light entrance surface 19b per unit area gradually varies according to the distance from the screw member 22. Accordingly, a partial dark portion that is caused due to the screw member 22 is less likely to be caused in the light entrance surface 19b or the light exit surface 19a of the light guide plate 19, and thus uneven brightness is less likely to occur in the light exiting the backlight unit 12. As a result, a high quality display image can be displayed on the liquid crystal panel 11.

Specifically, the arrangement interval variation LEDs 24 are arranged as follows. The interval P1 between the first LEDs 24a that are located closest to the screw member 22 has the maximum value. The interval P2 between the first LED 24a and the second LED 24b adjacent to the first LED 24a has a smaller value next to P1. The interval P3 between the second LED 24b and the third LED 24c adjacent to the second LED 24b has a smaller value next to the interval P2. The intervals P1 to P3 between the arrangement interval variation LEDs 24 vary continuously and gradually according to the distance from the screw member 22. Light from the LED 17 spreads from the main light-emitting surface 17a to a certain range with respect to the X-Z plane and reaches the light entrance surface 19b of the light guide plate 19. The amount of incident light per unit area in the light entrance surface 19b tends to decrease as the interval between the adjacent LEDs 17 decreases, and on the contrary, the amount of incident light per unit area in the light entrance surface 19b tends to increase as the interval between the adjacent LEDs 17 increases. As described above, the intervals P1 to P3 between the arrangement interval variation LEDs 24 gradually vary. Therefore, the amount of incident light per unit area in the light entrance surface 19b continuously and gradually varies according to the distance from the screw member 22. If the amount of incident light per unit area is partially small, a partial dark portion may be caused. However, in this embodiment, the amount of incident light per unit area in the light entrance surface 19b continuously and gradually varies, and thus the partial dark portion is less likely to be caused in the light entrance surface 19b. As a result, uneven brightness is less likely to occur among rays of the light exiting from the light exit surface 19a of the light guide plate 19 and the backlight 12.

Further, as illustrated in FIG. 4, the LEDs 17 include the arrangement interval constant LEDs 25 that are located further away from the screw member 22 than the arrangement interval variation LEDs 24. The arrangement interval constant LEDs 25 are arranged at the substantially constant intervals P4 and P5 regardless of the distance from the screw member 22. If compared to a case in which all LEDs are arrangement interval variation LEDs, the interval between the LEDs that are arranged away from the screw member 22 is less likely to be too small in this configuration. Herein, the interval between the adjacent LEDs 17 has an optimum value that achieves an optimum amount of incident light per unit area in the light entrance surface 19b. The intervals P1 to P3 between the arrangement interval variation LEDs 24 are gradually reduced according to the distance from the screw member 22, and the interval will reach the optimum value. When the interval reaches the optimum value, the arrangement interval constant LEDs 25 that are arranged at constant intervals are arranged. Accordingly, the intervals P4 and P5 between the arrangement interval constant LEDs 25 can be maintained to be the optimum value regardless of the distance from the screw member 22. As a result, uneven brightness is further less likely to occur among rays of light from the light exit surface 19a of the light guide plate 19 and the backlight unit 12.

As described above, the light emitted from the LEDs 17 and entering the guide plate 19 through the light entrance surface 19b is diffusely reflected by the light reflection portions 23 and exits through the light exit surface 19a. As illustrated in FIGS. 4 and 6, the dots of the light reflection portions 23 include the area variation dots 26, which are arranged such that the area distribution thereof in the plane of the plate surface (the light exit surface 19a, the plate surface 19c) of the light guide plate 19 becomes smaller as the distance from the screw member 22 in the X-axis direction (the arrangement direction of the LEDs 17) increases. The arrangement region 26A where the area variation dots 26 are arranged corresponds to the arrangement region where the arrangement interval variation LEDs 24 are arranged. Light from each arrangement interval variation LED 24 is reflected by the corresponding area variation dots 26 and thus the amount of light exiting from the light exit surface 19a is equalized. Specifically, the first LEDs 24a are arranged at the relatively large interval P1, and rays of light exited from the first LEDs 24a to the light guide plate 19 through the light entrance surface 19b are more likely to be reflected by the dots having relatively large areas among the area variation dots 26. The second LED 24b is arranged to have the relatively small interval P2, and rays of light emitted from the second LED 24b and entering the light guide plate 19 through the light entrance surface 19b are less likely to be reflected by the dots having relatively small areas among the area variation dots 26. The third LED 24c is arranged to have the relatively smaller interval P3, and rays of light emitted from the third LED 24c and entering the light guide plate 19 through the light entrance surface 19b are further less likely to be reflected by the dots having relatively smaller areas among the area variation dots 26. With this configuration, in the light exit surface 19a of the light guide plate 19, the amount of light exiting the arrangement region 26A including the area variation dots 26 is further effectively equalized in the plane and the uneven brightness is further less likely to occur.

As illustrated in FIGS. 4 and 6, in addition to the area variation dots 26, the dots of the light reflection portions 23 include the area constant dots 27. The area constant dots 27 are arranged such that the area distribution thereof in the plane of the plate surface of the light guide plate 19 is substantially constant regardless of the distance from the screw member 22 in the X-axis direction. The arrangement region 27A where the area constant dots 27 are arranged substantially corresponds to the arrangement region where the arrangement interval constant LEDs 25 are arranged. Therefore, light from the arrangement constant LEDs 25 is reflected by the area constant dots 27 and thus the amount of light exiting through the light exit surface 19a is equalized. Specifically, the fourth LEDs 25a and the fifth LEDs 25b included in the arrangement interval constant LEDs 25 are arranged at the substantially constant intervals P4 and P5, and thus the amount of light entering through the light entrance surface 19b per unit area is substantially constant. The light entering through the light entrance surface 19b is reflected by the area constant dots 27 having the substantially constant area. Therefore, the amount of light exiting through the arrangement region 27A where the arrangement interval constant dots 27 are arranged is equalized in the plane. With this configuration, uneven brightness is further less likely to occur.

The LEDs 17 mounted on the LED board 18 generate heat by light emission. The LED board 18 of this embodiment is made of synthetic resin having a coefficient of thermal expansion higher than that of metal. Therefore, an expansion or contraction amount of the LED board 18 due to thermal expansion or thermal contraction is large. However, as illustrated in FIGS. 4 and 5, the LED board 18 is attached to the chassis 14 with the screw member 22 at the substantially middle portion of the LED board 18 in the length direction of the LED board 18. Therefore, the LED board 18 can expand or contract in the length direction or the left and right direction regarding the attachment portion with the screw member 22 as an original point. Accordingly, deformation such as warping or deflection that may occur due to restriction of expansion or contraction is less likely to occur in the LED board 18.

As described above, the backlight unit (the lighting device) 12 according to this embodiment includes the LEDs (the light sources) 17, the light guide plate 19, the LED board (the light source board) 18, the chassis (a mount member) 14, the screw member (a board attachment member) 22, the arrangement interval variation LEDs (arrangement interval variation light sources) 24. The light guide plate 19 includes the end surface (the light entrance surface 19b) and the plate surface (the light exit surface 19a). The end surface is opposite the LEDs 17. Light from the LEDs 17 enters the light guide plate 19 through the end surface and exits the light guide plate 19 through the plate surface. The LED board 18 is provided with the LEDs 17 mounted thereto such that the LEDs 17 are arranged at intervals along the end surface of the light guide plate 19. The chassis 14 is provided with the LED board 18 attached thereto. The screw member 22 is disposed between the LEDs 17 adjacent to each other and attaches the LED board 18 to the chassis 14. The arrangement interval variation LEDs 24 are included in the LEDs 17 and arranged such that the intervals P1 to P3 between the arrangement interval variation LEDs 24 decrease as the distance from the LED board 18 increases.

In the above configuration, light emitted from the LEDs 17 enters the light guide plate 19 through the end surface and travels within the light guide plate 19 and then exits the light guide plate 19 through the plate surface. The LED board 18 includes the LEDs 17 mounted thereto such that the LEDs 17 are arranged at intervals along the end surface of the light guide plate 19. The screw member 22 to attach the LED board 18 to the chassis 14 is disposed between the LEDs 17 that are adjacent to each other. The interval between the adjacent LEDs 17 with the screw member 22 therebetween tends to be large because a space needs to be provided to arrange the screw member 22. Accordingly, the amount of light entering through the end surface of the light guide plate 19 may be partially small, and a dark portion may be caused. However, as is described earlier, the LEDs 17 include the arrangement interval variation LEDs 24 that are arranged such that the intervals P1 to P3 therebetween decrease as the distance from the screw member 22 increases. Therefore, the amount of light traveling from at least the arrangement interval variation LEDs 24 to the end surface of the light guide plate 19 per unit area gradually varies according to the distance from the screw member 22. Accordingly, a dark portion is less likely to occur at the end surface of the light guide plate 19, and thus uneven brightness is less likely to occur in the exiting light.

The arrangement interval variation LEDs 24 include at least a pair of the first LEDs 24a, the second LED 24b, and the third LED 24c. The first LEDs 24a are arranged with the screw member 22 therebetween. The second LEDs 24b is arranged adjacent to at least one of the first LEDs 24a such that the interval between the at least one of the first LEDs 24a and the second LED 24b is smaller than the interval between the first LEDs 24a. The third LEDs 24c is arranged adjacent to the second LEDs 24b such that the interval between the second LED 24b and the third LED 24c is smaller than the interval between the at least one of the first LEDs 24a and the second LED 24b. In the above configuration, the intervals gradually decrease in the following sequence: the interval P1 provided between the first LEDs 24a that are arranged with the screw member 22 in between, the interval P2 provided between the one of the first LEDs 24a and the second LED 24b adjacent to the one of the first LEDs 24a, and the interval P3 provided between the second LED 24b and the third LED 24c adjacent to the second LED 24b. Accordingly, the amount of light entering through the end surface of the light guide plate 19 gradually varies according to the distance from the screw member 22, and thus a dark portion is less likely to occur.

The light reflection portions 23 are configured to reflect light in the light guide plate 19 toward a light exit side to increase light exiting from the plate surface of the light guide plate 19 and arranged such that the area distribution of the light reflection portions 23 in the plate of the plate surface of the light guide plate 19 decreases along the arrangement direction of the LEDs 17 as the distance from the screw member 22 increases. In the above configuration, the light reflection portions 23 that are configured to reflect light in the light guide plate 19 toward the light exit side are arranged such that the area distribution thereof in the plane of the plate surface of the light guide plate 19 decreases as the distance from the screw member 22 along the arrangement direction of the LEDs 17 increases. Therefore, light from the LEDs 17 arranged at the relatively large interval P1 is more likely to be reflected by the light reflection portions 23, and light from the LEDs 17 arranged at the relatively small interval P3 is less likely to be reflected by the light reflection portions 23. Accordingly, the amount of light exiting from the plate surface of the guide plate 19 is equalized in the plane, and thus uneven brightness is less likely to occur.

The LEDs 17 include the arrangement interval constant LEDs 25 (the arrangement interval constant light sources) that are located further away from the screw member 22 than the arrangement interval variation LEDs 24 and arranged such that the intervals P4 and P5 between the arrangement interval constant LEDs 25 are constant regardless of the distance from the screw member 22. If the interval between the LEDs 17 is too small, the amount of light entering through the end surface of the light guide plate 19 may partially increase and a bright portion may be caused. However, as described above, the arrangement interval constant LEDs 25, which are located further away from the screw member 22 than the arrangement interval variation LEDs 24, are arranged such that the intervals P4 and P5 are constant regardless of the distance from the screw member 22. Therefore, the interval is less likely to be too small and thus uneven brightness is further less likely to occur.

The arrangement interval variation LEDs 24 are arranged such that the intervals P1 to P3 therebetween continuously and gradually decrease as the distance from the screw member 22 increases. With the above configuration, the amount of incident light to the end surface of the light guide plate 19 further gradually varies according to the distance from the screw member 22 with respect to the arrangement direction of the LEDs 17. Accordingly, dark portions are less likely to occur and thus uneven brightness is further less likely to occur.

The screw member 22 is located at the substantially middle portion of the LED board 18 with respect to the arrangement direction of the LEDs 17. In this configuration where the screw member 22 is arranged in the substantially middle portion of the LED board 18 with respect to the arrangement direction of the LEDs 17, if a dark portion where the amount of light entering through the end surface of the light guide plate 19 is locally small is caused, the dark portion is more likely to be noticeable. However, in the above configuration, the arrangement interval variation LEDs 24 are arranged such that the intervals P1 to P3 therebetween gradually vary according to the distance from the screw member 22. Therefore, the dark portion is less likely to be caused at the middle portion of the light guide plate 19, and thus uneven brightness is less likely to occur. Further, since the screw member 22 is arranged at the substantially middle portion of the LED board 18, the LED board 18 can extend or shrink according to thermal expansion or thermal contraction. Accordingly, deformation such as warping or deflection is less likely to occur.

One of the outer peripheral surfaces of the light guide plate surfaces of the light guide plate 19 is the light entrance surface (the light source opposed surface) 19b opposite to the LEDs 17. Other surfaces thereof are the LED non-opposed surfaces (the light source non-opposed surface) 19d of the light guide plate 19 that are not opposite the LEDs 17. In this configuration, only one end surface of the light guide plate 19 among the outer peripheral surfaces thereof is the light entrance surface 19b and the others are the LED non-opposed surfaces 19d. Therefore, a larger amount of light tends to enter through the light entrance surface 19b compared to a configuration in which two or more end surfaces of a light guide plate are the light entrance surfaces. If a dark portion, where the amount of light entering through the end surface of the light guide plate 19 is locally small is caused, the dark portion is more likely to be noticeable. However, in the above embodiment, the arrangement interval variation LEDs 24 are arranged such that the intervals P1 to P3 therebetween gradually vary according to the distance from the screw member 22. Therefore, the dark portion is less likely to be caused at the middle portion of the light guide late 19 and thus uneven brightness is less likely to occur.

The LEDs 17 are arranged in symmetrical with respect to the screw member 22 on the LED board 18. In this configuration, the LEDs 17 are arranged in symmetrical with respect to the screw member 22. Therefore, the amount of light entering through the end surface of the light guide plate 19 symmetrically varies according to the arrangement of the LEDs 17, and thus uneven brightness is less likely to occur.

The light reflection portions 23 are configured to reflect light in the light guide plate 19 toward the light exit side to increase light exiting from the plate surface of the light guide plate 19. The light reflection portions 23 are arranged such that an area distribution of the light reflection portions 23 in the plate of the plate surface of the light guide plate 19 decreases along the arrangement direction of the LEDs 17 as the distance from the screw member 22 increases. Further, the light reflection portions 23 are in symmetrical with respect to the screw member 22 along the arrangement direction of the LEDs 17. In this configuration, the light reflection portions 23, which are configured to reflect rays of light inside the light guide plate 19 toward the light emitting side, are arranged such that areas of the light reflection portions decrease as the distance from the screw member 22 increases in the arrangement direction of the LEDs 17 in the area distribution of the light reflection portions 23 within a plane of the plate surface of the light guide member. Further, the area distribution of the light reflection portions 23 is symmetrical with respect to the screw member 22 in the arrangement direction of the LEDs 17. Therefore, light from the LEDs 17 that are arranged at the relatively larger interval P1 therebetween is more likely to be reflected by the light reflection portions 23, and light from the LEDs 17 that are arranged at the relatively smaller interval P3 therebetween is less likely to be reflected by the light reflection portions 23. Further, a distribution of an overall amount of the reflected light is symmetrical as described above. Accordingly, light exiting through the plate surface of the light guide plate 19 is further equalized in the plane and thus uneven brightness is further less likely to occur.

The projection height of the screw member 22 from the LED board 18 is smaller than the projection height of the LEDs 17 from the LED board 18. With this configuration, light from the LEDs 17 is less likely to be blocked by the screw member 22 and uneven brightness is further less likely to occur.

The backlight unit 12 further includes the chassis 14 that holds the LED board 18 and the light guide plate 19. The chassis 14 is the mount member to which the LED board 18 is mounted. With this configuration, the LED board 18 can be attached to the chassis 14 with the screw member 22.

### Second Embodiment

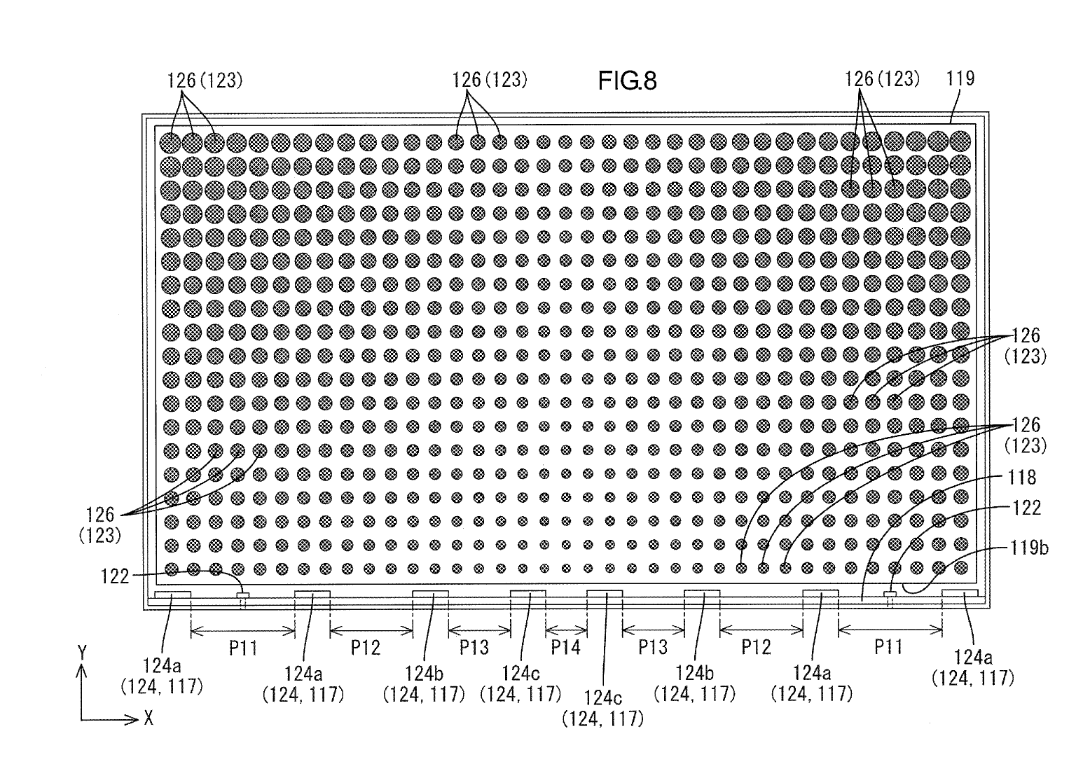

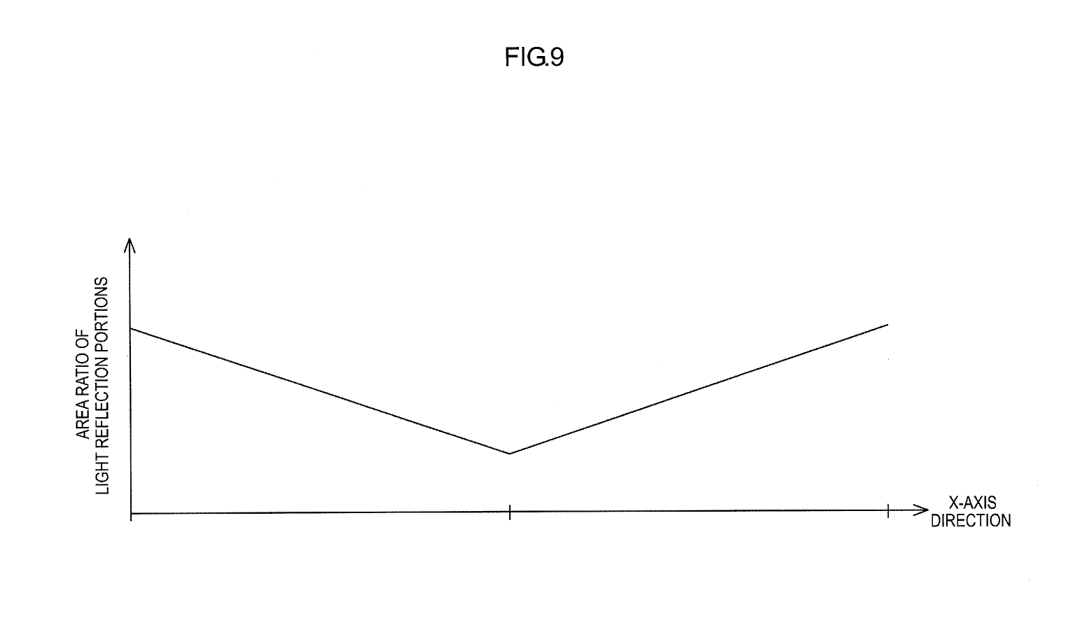

A second embodiment of this invention will be described with reference to FIGS. 8 and 9. In the second embodiment, arrangement of screw members 122 and arrangement of LEDs 117 are altered from ones in the first embodiment. The same structures, operations, and effects as those of the first embodiment will not be described.

As illustrated in FIG. 8, the screw members 122 according to this embodiment are arranged at end portions of an LED board 118. Specifically, eight LEDs 117 are arranged in a line on the LED board 118 along a length direction (the X-axis direction) of the LED board 118, and each of the screw members 122 is disposed between each of end-side LEDs 117 that are located closest to the ends of the LED board 118 in the length direction and a LED 117 adjacent to each end-side LED 117. All of the LEDs 117 mounted on the LED board 118 are arrangement interval variation LEDs 124 that are arranged at intervals P11 to P14 that continuously and gradually vary.

Specifically, the arrangement interval variation LEDs 124 include two pairs of first LEDs 124a (four in total), two second LEDs 124b, and two third LEDs 124c. Each pair of the first LEDs 124a that are adjacent to each other is arranged so as to sandwich the screw member 122 in between. The second LEDs 124b are adjacent to the first LEDs 124a located close to a middle portion of the LED board 118. The third LEDs 124c are arranged adjacent to the respective second LEDs 124b. Among all of the LEDs 117, the end-side LEDs 117 that are located closest to the ends of the LED board 118 and the LEDs 117 next to the respective end-side LEDs 117 are the first LEDs 124a. Among all of the LEDs 117, the third LEDs 124c are located closest to the middle portion of the LED board 118. The second LEDs 124b are arranged closer to the middle portion of the LED board 118 next to the third LEDs 124c. Herein, “P11” denotes an interval between the pair of first LEDs 124a, “P12” denotes an interval between the first LED 124a and the second LED 124b, P13″ denotes an interval between the second LED 124b and the third LED 124c, “P14” denotes an interval between the pair of the third LEDs 124c, and a size relation of the intervals satisfies an inequality of “P11>P12>P13>P14”. P11 has a maximum value and P14 has a minimum value. Specifically, a dimension of P11 is about 5 mm, a dimension of P12 is about 4 mm, a dimension of P13 is about 3 mm, and a dimension of P14 is about 2 mm.

All dots included in light reflection portions 123 of a light guide plate 119 are area variation dots 126. The area variation dots 126 are patterned as illustrated in FIGS. 8 and 9. Specifically, an area ratio of the area variation dots 126 per unit area in a plane of a plate surface of the light guide plate 119 is the largest at end portions of the light guide plate 119 with respect to the X-axis direction (an arrangement direction of the LEDs 117). In other words, the area ratio of the area variation dots 126 is the largest at portions corresponding to the end-side first LEDs 124a among the arrangement interval variation LEDs 124 with respect to the X-axis direction. The area ratio gradually decreases as a distance from each end portion of the light guide plate 119 to a middle portion of the light guide plate 119 in the X-axis direction decreases, and the area ratio has a minimum value in the middle portion of the light guide plate 119. In other words, the area ratio of the area variation dots 126 per unit area in the plane of the plate surface of the light guide plate 119 peaks at the end portions of the light guide plate 119 in the long-side direction (the X-axis direction), and the area ratio continuously and gradually decreases as the distance therefrom to the middle portion of the light guide plate 119 decreases. In this configuration, rays of light from the arrangement interval variation LEDs 124 enter the light guide plate 119 through a light entrance surface 119b. The rays of light are reflected by the area variation dots 126 that are arranged so as to correspond to the intervals P11 to P14. As a result, the exiting rays of light are equalized at the plane of the light guide plate 119. The LED board 118 in this embodiment is made of metal or ceramic having a coefficient of thermal expansion lower than that of synthetic resin material. Accordingly, an expansion or contraction amount due to thermal expansion or thermal contraction is small, and thus deformation such as warping or deflection is less likely to occur even if the end portions of the LED board 118 are fixed with the screw members 122.

### Third Embodiment

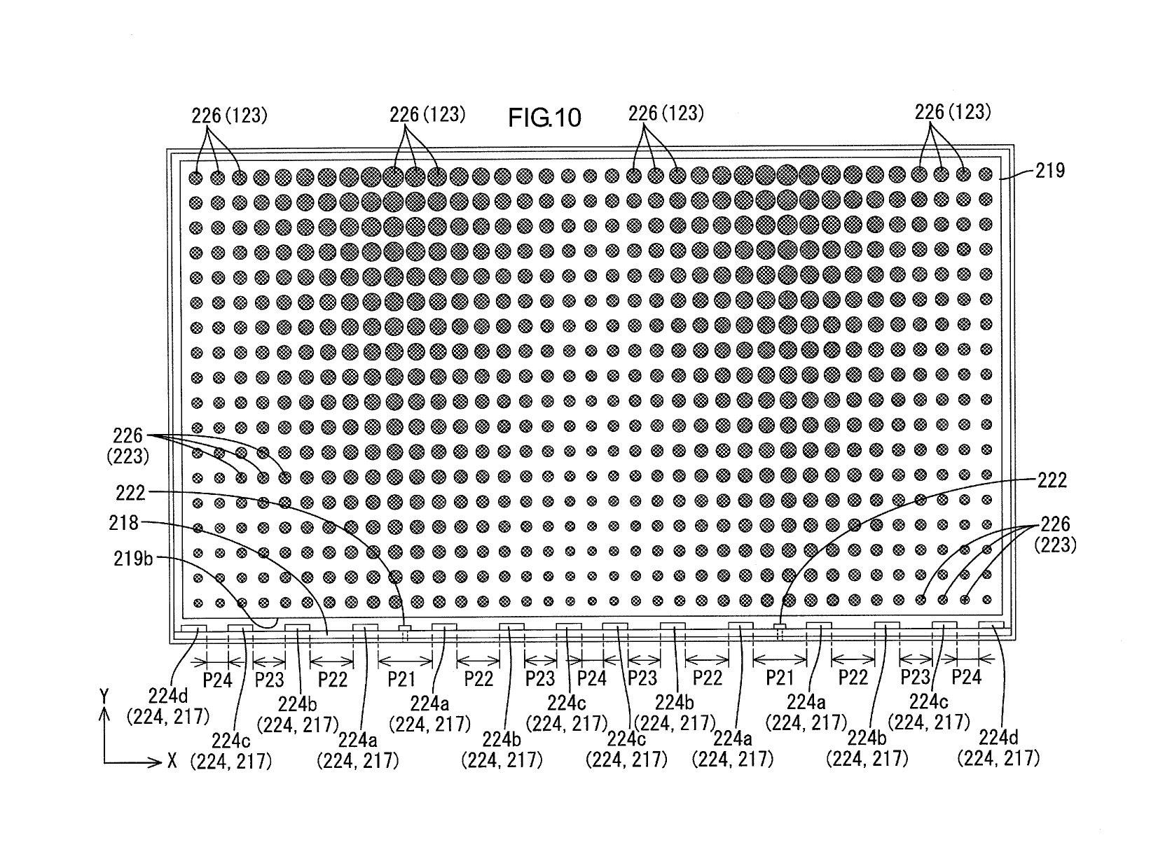

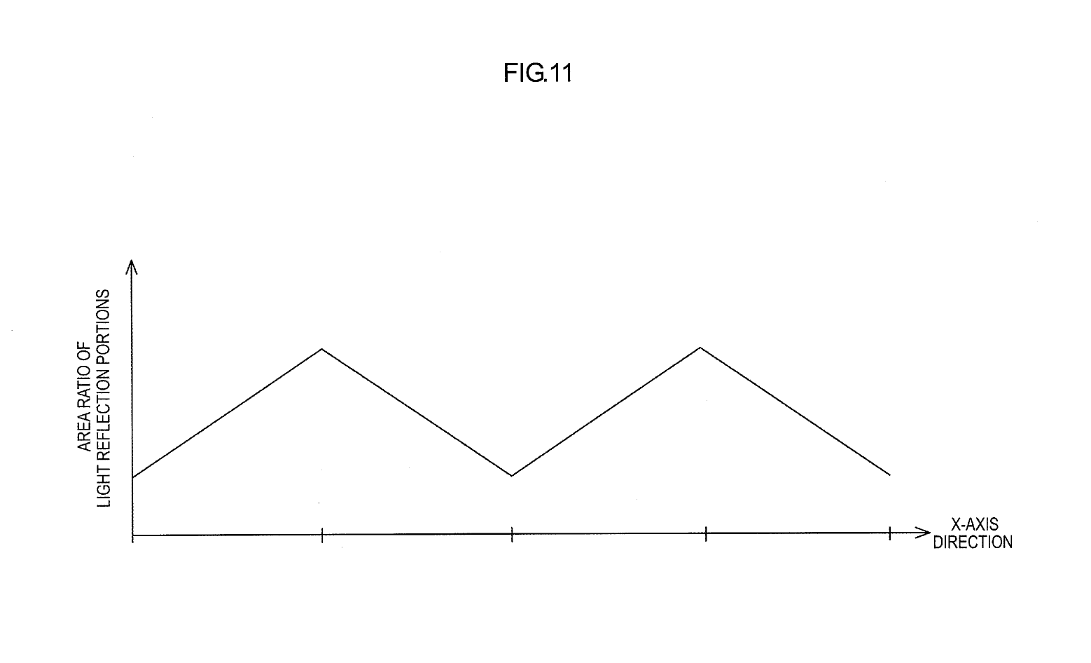

A third embodiment of this invention will be described with reference to FIGS. 10 and 11. In the third embodiment, arrangement of screw members 222 and arrangement of LEDs 217 are changed from those of the second embodiment. The same structures, operations, and effects as those of the second embodiment will not be described.

As illustrated in FIG. 10, the screw members 222 according to this embodiment are arranged in intermediate portions of an LED board 218 between the end portions and a middle portion of the LED board 218. Specifically, a total of fourteen LEDs 217 are arranged in a line on the LED board 218 along a length direction (the X-axis direction) of the LED board 218. Each of the screw members 222 is arranged between the fourth LED 217 from an end of the LED board 218 in the length direction and the adjacent LED 217 on a middle side of the fourth LED 217.

All the LEDs 217 are arrangement interval variation LEDs 224. The arrangement interval variation LEDs 224 include two pairs of first LEDs 224a (four in total), two pairs of second LEDs 224b (four in total), two pairs of third LEDs 224c (four in total), and a pair of fourth LEDs 224d. Each pair of the first LEDs 224a is arranged so as to sandwich a screw member 222 in between. Each pair of the second LEDs 224b is adjacent to the first LEDs 224a in each pair. Each pair of the third LEDs 224c is adjacent to the second LEDs 224b in each pair. Each of the fourth LEDs 224d is adjacent to one of third LEDs 224c on an outer side. The third LEDs 224c on an inner side are located closest to the middle portion of the LED board 218. The fourth LEDs 224d are located closest to the ends of the LED board 218. Herein, when “P21” denotes an interval between the first LEDs 224a, “P22” denotes an interval between the second LED 224a and the second LED 224b, “P23” denotes an interval between the second LED 224b and the third LED 224c, and “P24” denotes an interval between the third LEDs 224c adjacent to each other and an interval between the third LED 224c and the forth LED 224d, a size relation of the intervals satisfies an inequality of “P21>P22>P23>P24”. P21 has a maximum value and P24 has a minimum value. Specifically, a dimension of P21 is about 5 mm, a dimension of P22 is about 4 mm, a dimension of P23 is about 3 mm, and a dimension of P24 is about 2 mm.

As illustrated in FIGS. 10 and 11, light reflection portions 223 of a light guide plate 219 include area variation dots 226. The area variation dots 226 are pattered as follows. An area ratio of the area variation dots 226 per unit area in a plane of a plate surface of the light guide plate 219 is the smallest in three portions including both end portions and a middle portion of the light guide plate 219 with respect to the X-axis direction (an arrangement direction of the LEDs 217). The area ratio of the area variation dots 226 gradually decreases as a distance from each of the three portions increases, and the area ratio is the largest in a portion corresponding to the screw member 222 with respect to the X-axis direction. In this configuration, rays of light from the arrangement interval variation LEDs 224 enter the light guide plate 219 through a light entrance surface 219b, and the rays of light are reflected by the area variation dots 226 that are arranged so as to correspond to the intervals P21 to P24. As a result, the exiting rays of light are equalized in the plane of the light guide plate 219.

### Fourth Embodiment

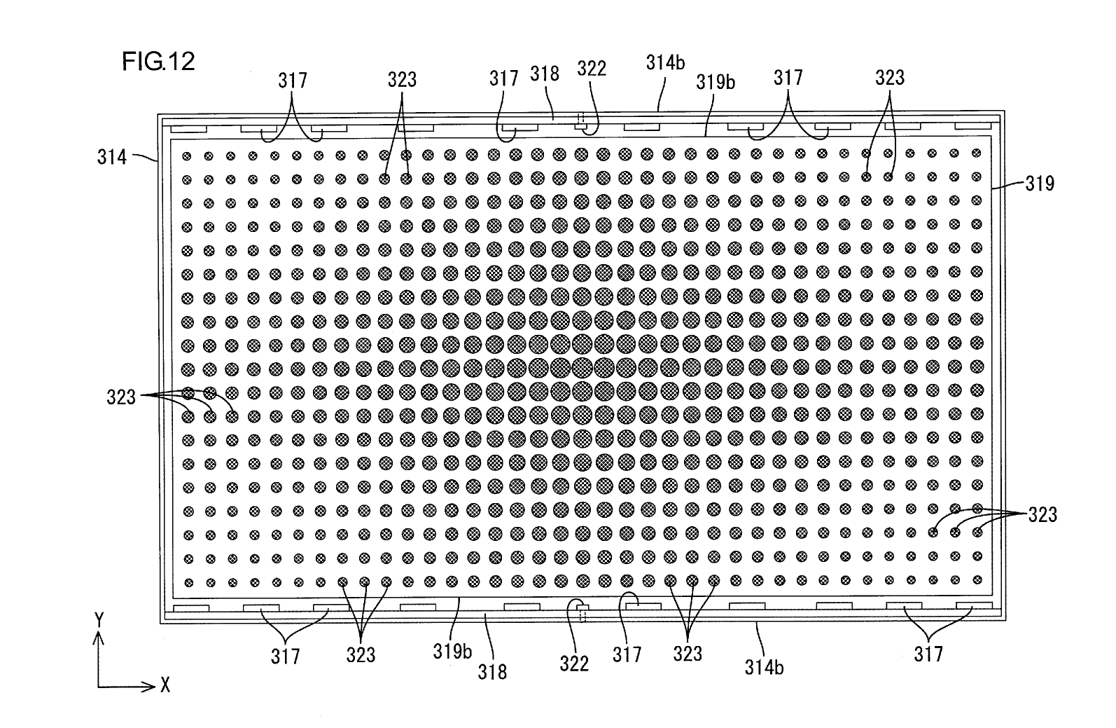

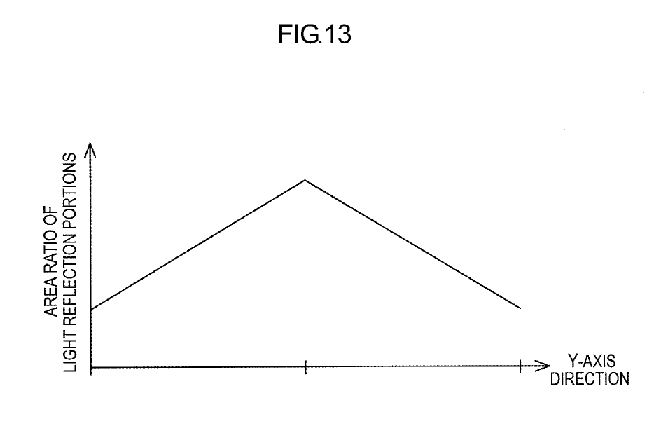

A fourth embodiment of this invention will be described with reference to FIGS. 12 and 13. In the fourth embodiment, a pair of LED boards 318 is arranged. The same structures, operations, and effects as those of the first embodiment will not be described.

As illustrated in FIG. 12, the LED boards 318 of this embodiment are arranged in long-side end portions of a chassis 314. The LED boards 318 are arranged so as to sandwich a light guide plate 319 from both sides of the light guide plate 319 with respect to a short-side direction (the Y-axis direction) of the light guide plate 319. The LED boards 318 are attached to long-side plates 314b of the chassis 314 with screw members 322. Among outer peripheral end surfaces of the light guide plate 319, long-side end surfaces of the light guide plate 319 are light entrances 319b. Light reflection portions 323 of the light guide plate 319 are pattered as illustrated in FIGS. 12 and 13. Specifically, an area ratio of the light reflection portion 323 per unit area in a plane of a plate surface of the light guide plate 319 is the smallest in end portions of the light guide plate 319 with respect to the Y-axis direction (an arrangement direction between the LEDs 317 and the light guide plate 319), and gradually increases as a distance from the end portion increases, and the area ratio is the largest in a middle portion of the light guide plate 319. The area ratio of the light reflection portion 232 in the X-axis direction varies similar to the first embodiment. Accordingly, among dots of the light reflection portions 323, dots arranged in the middle portion of the light guide plate 319 in the X and Y directions have the largest area ratio, and dots arranged at four corners of the light guide plate 319 have the smallest area ratio.

### Fifth Embodiment

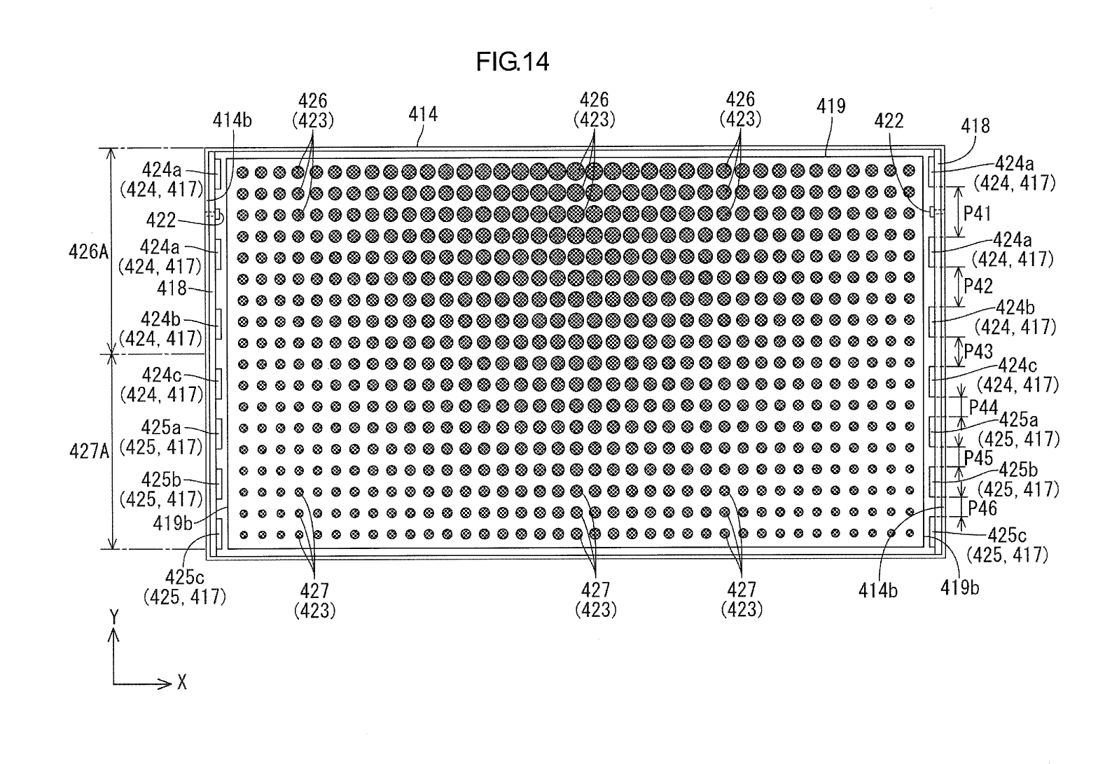

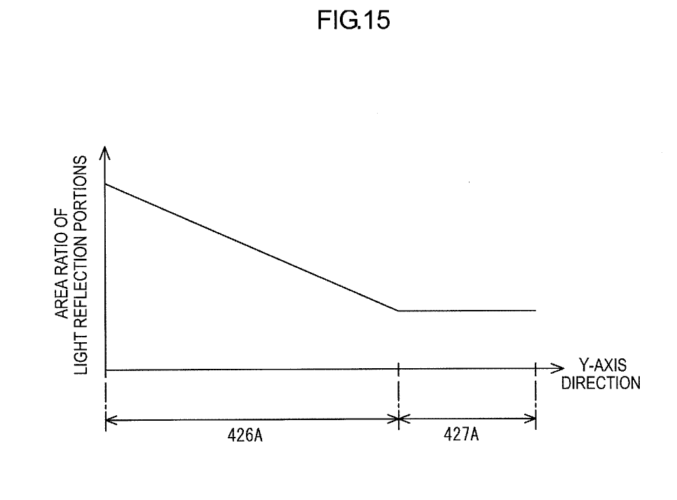

A fifth embodiment of this invention will be described with reference to FIGS. 14 and 15. In the fifth embodiment, arrangement of LED boards 418 is altered from one in the first embodiment. The same structures, operations, and effects as those of the first embodiment will not be described.

As illustrated in FIG. 14, the LED boards 418 according to this embodiment are arranged in short-side end portions of a chassis 414 so as to sandwich a light guide plate 419 from sides of the light guide plate 419 with respect to a long-side direction (the X-axis direction) of the light guide plate 419. Among outer peripheral end surfaces of the light guide plate 419, short-side end surfaces thereof are light entrance surfaces 419b. Each LED board 18 is attached to a short-side plate 414b of the chassis 414 with a single screw member 422. The screw member 422 is located close to one (an upper side in FIG. 14) of end portions of the LED board 418 with respect to a length direction (the Y-axis direction) of the LED board 418.

As illustrated in FIG. 14, LEDs 417 mounted on the LED boards 418 include arrangement interval variation LEDs 424. The arrangement interval variation LEDs 424 in each LED board 418 include a pair of first LEDs 424a, a second LED 424b, and a third LED 424c. The first LEDs 424a are arranged adjacent to each other with the screw member 422 in between. The second LED 424b is adjacent to one of the first LEDs 424a that is on a middle side (a side opposite to the screw member 422) of the LED board 418. The third LED 424c is adjacent to the second LED 424b. Herein, when “P41” denotes an interval between the pair of the first LEDs 424a, “P42” denotes an interval between the first LED 424a and the second LED 424b, and “P43” denotes an interval between the second LED 424b and the third LED 424c, a size relation of the intervals satisfies “P41>P42>P43”. P41 has a maximum value and the P43 has a minimum value. Specifically, a dimension of P41 is about 5 mm, a dimension of P42 is about 4 mm, and a dimension of P43 is about 3 mm.

As illustrated in FIG. 14, the LEDs 417 include arrangement interval constant LEDs 425 in addition to the arrangement interval variation LEDs 424. The arrangement interval constant LEDs 425 in each LED board 418 include a fourth LED 425a, a fifth LED 425b, and a sixth LED 425c. The fourth LED 425a is adjacent to the third LED 424c, which is one of the arrangement interval variation LEDs 424, on an opposite side of the third LED 424c from the second LED 424b. The fifth LED 425b is adjacent to the fourth LED 425a. The sixth LED 425c is adjacent to the fifth LED 425b. The sixth LED 425c is located in an opposite end portion of the LED board 418 from a screw member 422 side. Herein, when “P44” denotes an interval between the third LED 424c and the fourth LED 425a, “P45” denotes an interval between the fourth LED 425a and the fifth LED 425b, and “P46” denotes an interval between the fifth LED 425b and the sixth LED 425c, a relation of the intervals satisfies an equality of “P44=P45=P46” and an inequality of “P43>P44=P45=P46”. Specifically, a dimension of P4, a dimension of P5, and a dimension of P6 are about 2 mm and substantially the same. As is just described, the arrangement interval variation LEDs 424 and the arrangement interval constant LEDs 425 are arranged in asymmetrical with respect to a symmetrical line that passes through a middle of the LED board 418 in the length direction.

Dots included in light reflection portions 423 of the light guide plate 419 include area variation dots 426 and area constant dots 427. The area variation dots 426 are patterned as illustrated in FIGS. 14 and 15. An area ratio per unit area in a plane of a plate surface of the light guide plate 419 is the largest in an upper end portion of the light guide plate 419 in FIG. 14 with respect to the Y-axis direction (an arrangement direction of the LEDs 417). In other words, the area ratio is the largest at a portion corresponding to the first LEDs 424a that are located closest to the end among the arrangement interval variation LEDs 424 with respect to the Y-axis direction. The area ratio gradually decreases toward a lower side in FIG. 14 along the Y-axis direction. An arrangement region 426A where the area variation dots 426 are arranged substantially corresponds to an arrangement region where the arrangement interval variation LEDs 424 are arranged. The area constant dots 427 are arranged in a lower portion of the light guide plate 419 in FIG. 14 with respect to the Y-axis direction. The area constant dots 427 are patterned such that an area ratio per unit area in the plane of the plate surface of the light guide plate 419 are substantially constant regardless of positions with respect to the Y-axis direction. An arrangement region 427A where the area constant dots 427 are arranged corresponds to an arrangement region where the arrangement interval constant LEDs 425 are arranged. The area variation dots 426 and the area constant dots 427 included in the light reflection portions 423 are arranged in asymmetrical with respect to a symmetrical line that passes through a middle of the light guide plate 419 with respect to the short-side direction of the light guide plate 419.

### Sixth Embodiment

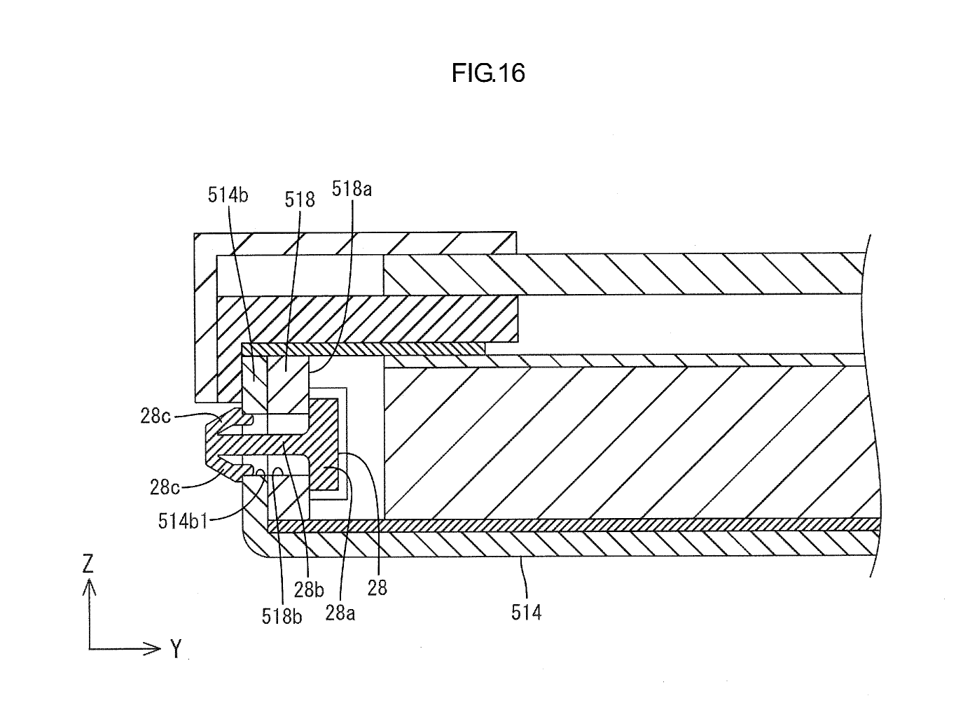

A sixth embodiment of this invention will be described with reference to FIG. 16. In the sixth embodiment, an LED board 518 is attached to a chassis 514 with a clip member 28. The same structures, operations, and effects as those of the first embodiment will not be described.

As illustrated in FIG. 16, the LED board 518 according to this embodiment is attached to a side-plate 514b of the chassis 514 with the clip member (the board attachment member) 28 that is made of synthetic resin. The clip member 28 includes a base portion 28a, a shaft portion 28b, and a pair of stopper portions 28c. The base portion 28a contacts a mount surface 518a of the LED board 518. The shaft portion 28b projects from the base portion 28a so as to penetrate an insertion hole 518b of the LED board 518 and an attachment hole 514b1 of the side-plate 514b. The stoppers 28c extend from a projected end of the shaft portion 28b toward the base portions 28a. The stoppers 28c stop at a peripheral portion of the attachment hole 514b1 of the side-plate 514b. The stopper portions 28c elastically deform with respect to the shaft portion 28b. Specifically, the stopper portions 28c can elastically deform so as to approach the shaft portion 28b. Accordingly, the stopper portions 28c can pass through the insertion hole 518b and the attachment portion 514b1. The LED board 518 is held between the side-plate 514b of the chassis 514 and the base portion 28a of the clip member 28.

### Seventh Embodiment

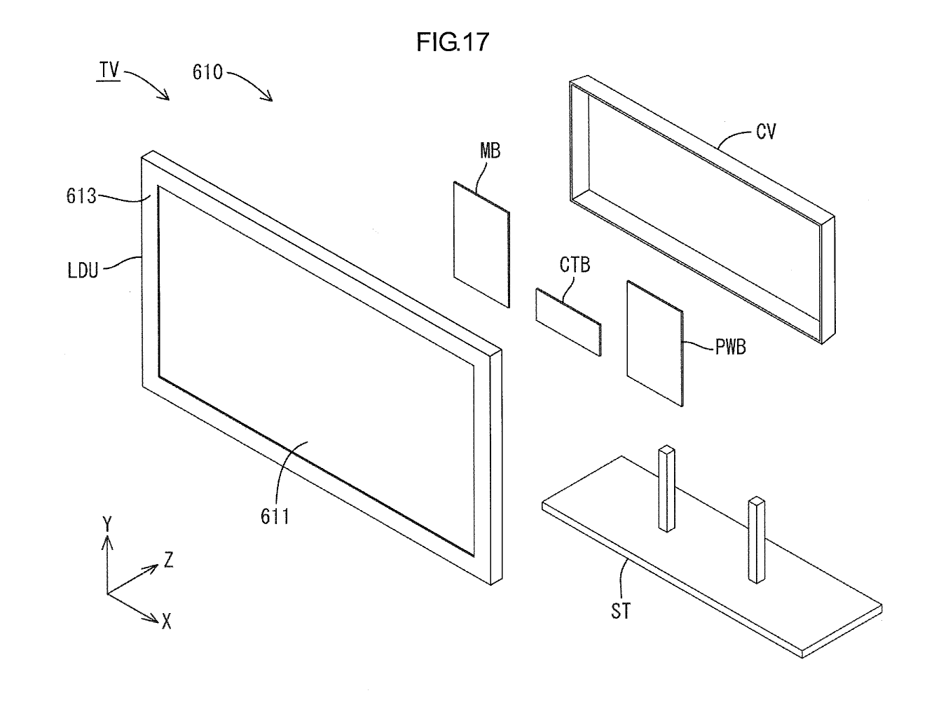

A seventh embodiment of the technology will be described with reference to FIGS. 17 to 19. According to the seventh embodiment, a television device TV does not include a cabinet. The same configurations, functions, and effects as those in the first embodiment will not be described.

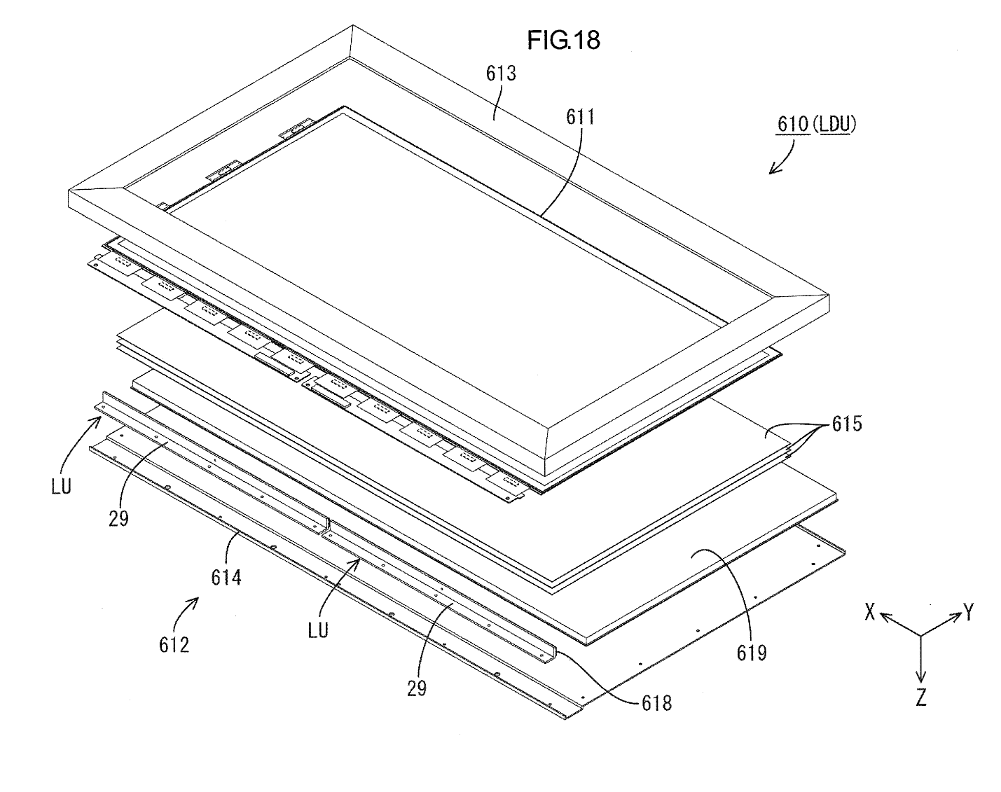

As illustrated in FIG. 17, the television device TV according to this embodiment includes a liquid crystal display unit (a display unit) LDU, circuit boards PWB, MB, and CTB, a cover CV, and a stand ST. The circuit boards PWB, MB, and CTB are attached to the rear surface (the back surface) of the liquid crystal display unit LDU. The cover CV is attached to the rear surface of the liquid crystal display unit LDU so as to cover the circuit boards PWB, MB, and CTB. The liquid crystal display unit LDU is supported by the stand ST with a display surface thereof held along the vertical direction (the Y-axis direction). A liquid crystal display device 610 in this embodiment is a part of the above-described television device TV at least other than a part configured to receive television signals (e.g., a tuner section of a main circuit board MB). As illustrated in FIG. 18, the liquid crystal display unit LDU has a landscape rectangular overall shape (an elongated shape). The liquid crystal display unit LDU includes a liquid crystal panel 611 and a backlight unit 612 collectively held by a bezel 613 and a chassis 614, which are components of the liquid crystal display device 610 to form an exterior of the liquid crystal display device 610. The chassis 614 in this embodiment is one of the components to form the exterior and a part of the backlight 612.

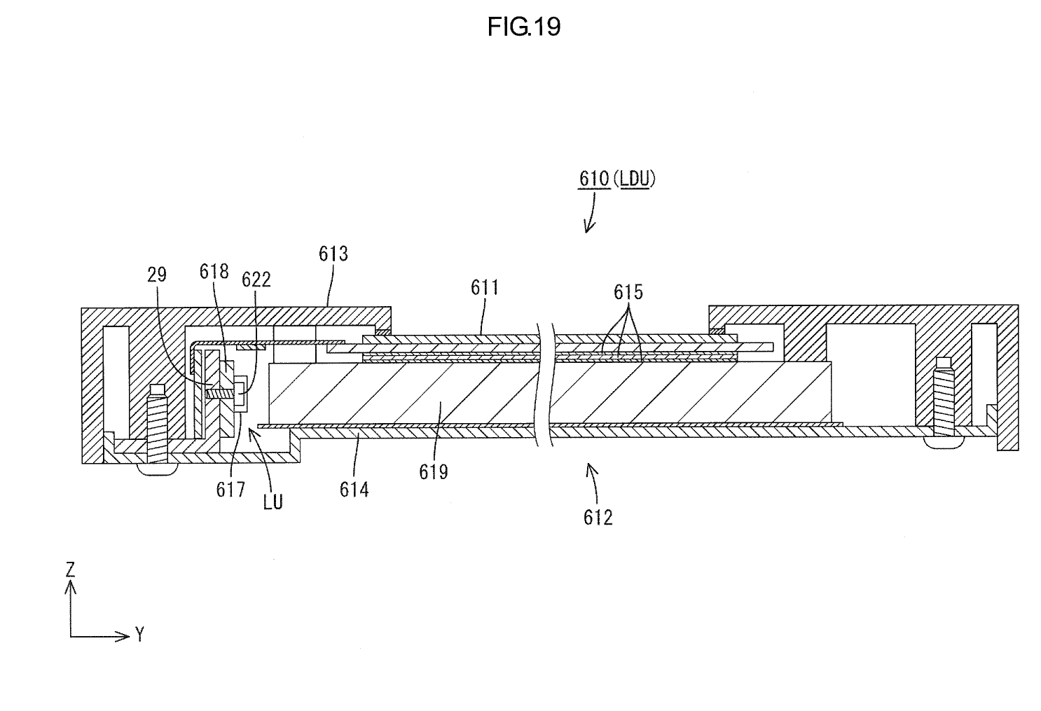

As illustrated in FIGS. 18 and 19, the liquid crystal display unit LDU of the liquid crystal display device 610 is arranged in a space between the bezel (a front frame) 613 that forms a front exterior and the chassis (a rear chassis) 614 that forms a rear exterior. Major components arranged between the bezel 613 and the chassis 614 include at least the liquid crystal panel 611, optical members 615, a light guide plate 619, and LED units (light source units) LU. The liquid crystal panel 611, the optical members 615, and the light guide plate 619 are layered directly onto each other and sandwiched between the bezel 613 on the front and the chassis 614 on the rear. The liquid crystal display device 610 in this embodiment does not include the frame 16 of the first embodiment arranged between the liquid crystal panel 11 and the optical member 15 (see FIGS. 2 and 3).

As illustrated in FIGS. 18 and 19, the backlight unit 612 includes the optical members 615, the light guide plate 619, the LED units LU, and the chassis 614, that is, apart of the liquid crystal display unit LDU other than the liquid crystal panel 611 and the bezel 613. The LED units LU included in the backlight unit 612 are arranged adjacent to the light guide plate 619 on a front side in FIG. 18 (a left side in FIG. 19) between the bezel 613 and the chassis 614, and arranged in a line along the X-axis direction. Each LED unit LU includes LEDs 617, an LED board 618 on which the LEDs 617 are mounted, and a heat dissipation member (a heat spreader, a mount base member) 29. The LED board 618 is attached to the heat dissipation member 29 by attaching a screw member 622 at a middle portion of the LED board 618 with respect to the length direction of the LED board 618.

### Eighth Embodiment

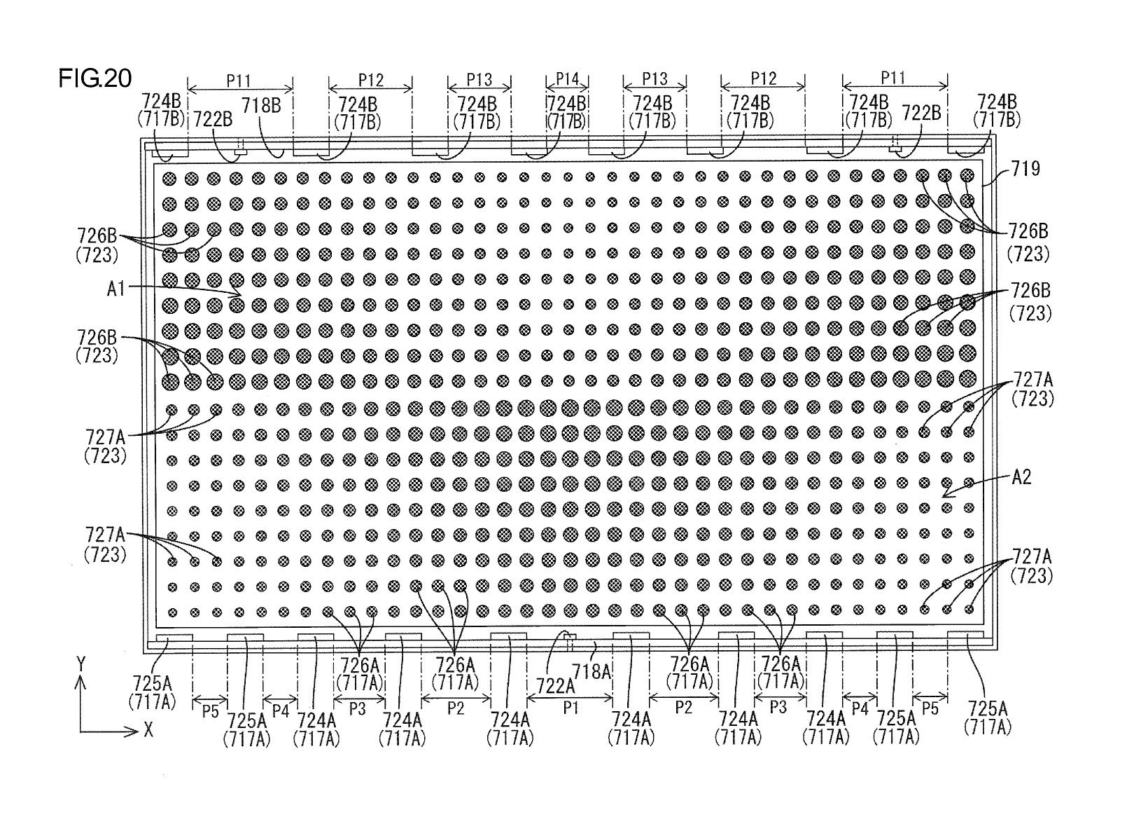

An eighth embodiment of this invention will be described with reference to FIG. 20. The eighth embodiment is a modification of the fourth embodiment. Arrangement of screw members 722A, 722B and arrangement of LEDs 717A, 717B in LED boards 718, 718B are different from ones of the above embodiment. The same structures, operations, and effects as those of the first embodiment will not be described.

As illustrated in FIG. 20, the LED boards 718A, 718B according to this embodiment are arranged so as to sandwich a light guide plate 719 from both sides of the light guide plate 719 with respect to its short-side direction (the Y-axis direction). One of the LED boards 718A and 718B that is on a lower side in FIG. 20 includes a screw member 722A and LEDs 717A. Arrangement of the screw member 722A and arrangement of the LEDs 717A are similar to those in the first embodiment. The other one of the LED boards 718A and 718B that is on an upper side in FIG. 20 includes screw members 722B and LEDs 717B. Arrangement of the screw member 722B and arrangement of the LEDs 722B are similar to those in the second embodiment. Specifically, on the LED board 718B arranged on the lower side in FIG. 20, one screw member 722A is attached at a substantially middle portion thereof with respect to the length direction. The LEDs 717A mounted on the LED board 718A include arrangement interval variation LEDs 724A and arrangement interval constant LEDs (arrangement interval constant light sources) 725A. The arrangement interval variation LEDs 724A are arranged at intervals P1 to P3 that decrease as a distance from the screw member 722A increases. The arrangement interval constant LEDs 725A are arranged at intervals P4 and P5 that are substantially constant regardless of the distance from the screw member 722A. Configurations of the intervals P1 to P5 between the LEDs 717A are the same as those in the first embodiment. On the other hand, on the LED board 718B arranged on the upper side in FIG. 20, two screw members 722B are attached to end portions thereof with respect to the length direction. All the LEDs 717B mounted on the LED board 718B are arrangement interval variation LEDs 724B that are arranged at intervals P11 to P14 decreasing as a distance from each screw member 722B increases. Configurations of the intervals P11 to P14 between the LEDs 717B are the same as those described in the second embodiment. On the LED boards 718A and 718B according to this embodiment, the arrangement of the LEDs 717A and 717B and the arrangement of the screw member 722A and 722B are asymmetric in an up-and-down direction in FIG. 20.

Corresponding to the arrangement of the LEDs 717A and 717B, light reflection portions 723 that are configured to direct more light to an outside of the light guide plate 719 have following configurations. The light guide plate 719 are divided into a first region A1 on a lower side of FIG. 20 and a second region A2 on an upper side of FIG. 20 along a long-side direction of the light guide plate 719. The light reflection portions 723 have different area distribution in the first region A1 and the second region A2. Specifically, in the first region A1, dots of the light reflection portions 723 includes area variation dots 726A and area constant dots 727A. An area distribution of the area variation dots 726A in a plane of a plate surface of the light guide plate 719 becomes smaller as a distance from the screw member 722A increases along the X-axis direction (an arrangement direction of the LEDs 717). An area distribution of the area constant dots 727A in the plane of the plate surface of the light guide plate 719 is constant regardless of the distance from the screw member 722A in the X-axis direction. Specific arrangement of the area variation dots 726A and the area constant dots 727A in the first region A1 is the same as those described in the first embodiment. On the other hand, in the second region A2, dots included in the light reflection portions 723 only include area variation dots 726B. In an area distribution of the area variation dots 726B in the plane of the plate surface of the light guide plate, areas of the area variation dots 726B decrease as a distance from each screw member 722B increases along the X-axis direction. Specific arrangement of the area variation dots 726B in the second region A2 is the same as those described in the second embodiment. Even in such a configuration, light emitted from the LED 717A and 717B of the respective LED boards 718A and 718B and entering the light guide plate 719 is reflected by the light reflection portions 723 having a dot pattern corresponding to the arrangement of the LEDs 717A and 717B. Thus, the amount of light exiting the light guide plate 719 is equalized in the plane.

### Ninth Embodiment

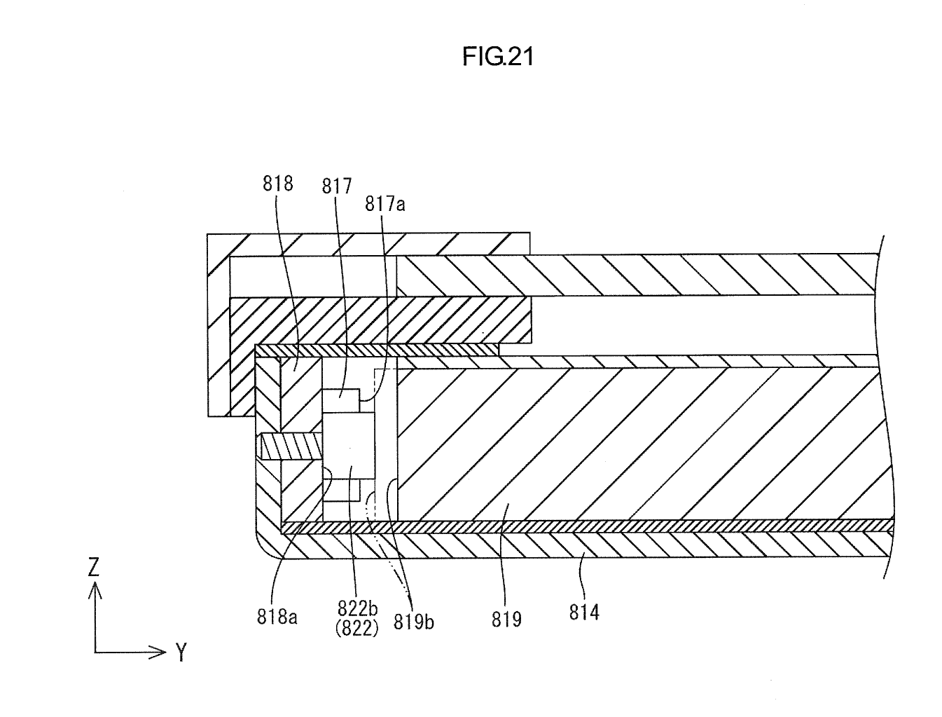

A ninth embodiment of this invention will be described with reference to FIG. 21. In the ninth embodiment, a screw member 822 is different from one in the first embodiment. The same structures, operations, and effects as those of the first embodiment will not be described.

As illustrated in FIG. 21, the screw member 822 according to this embodiment has a projection height (a thickness dimension of a head portion 822b) measured from a mount surface 818a of an LED board 818 that is greater than a projection height (a distance from the mount surface 818a to a main light-emitting surface 817a) of an LED 817 measured from the mount surface 818a of an LED board 818. In other words, the head portion 822b of the screw member 822 is located between the main light-emitting surface 817a of the LED 817 and a light entrance surface 819b of the light guide plate 819 with respect to the Y-axis direction (an arrangement direction between the LED 817 and the light guide plate 819). If an environmental temperature inside a chassis 814 increases and the light guide plate 819 expands due to thermal expansion, the light entrance surface 819b of the light guide plate 819 may displace closer to the LED 817 along the Y-axis direction. In such a case, the head portion 822b of the screw member 822 comes into contact with the light entrance surface 819b and restricts further displacement of the light entrance surface 819b toward the LED 817. With this configuration, the light entrance surface 819b of the light guide plate 819 is less likely to contact the LED 817 and thus the LED 817 is less likely to be damaged or broken. In FIG. 21, a thermally expanded light guide plate 819 is indicated by a double chain line.

### Other Embodiments

The technology is not limited to the above embodiments described in the above description and the drawings. For example, the following embodiments may be included in technical scopes of the technology.

(1) In the first and fifth embodiments, the LEDs include the arrangement interval variation LEDs and the arrangement interval constant LEDs. However, all of the LEDs included in the LED boards of the first and fifth embodiment may be the arrangement interval variation LEDs.

(2) In the second to fourth embodiments, all LEDs are arrangement interval variation LEDs. However, the LEDs on the LED boards of the second to fourth embodiments may include the arrangement interval variation LEDs and the arrangement interval constant LEDs.

(3) In addition to the above embodiments, the specific number the arrangement interval variation LEDs on the LED or the interval between the arrangement interval variation LEDs may be altered as appropriate. In similar, the specific number of the arrangement interval constant LEDs or the interval between the arrangement interval distant LEDs altered as appropriate.

(4) In the first and fourth embodiments, the screw member 22 is arranged in the middle portion of the LED board with respect to the long-side direction. However, the screw member may be at a position off (shifted) from the middle of the LED board in each of the first and fourth embodiments. In such a case, the arrangement of the arrangement interval variation LEDs or the arrangement of the arrangement interval variation LEDs may be altered as appropriate according to the arrangement of the screw member.

(5) In the second, third, and fifth embodiments, the screw members are located off from the middle portion of the LED board with respect to the long-side direction. However, the screw members may be located in the middle portion of the respective LED boards in the second, third, and fifth embodiments. In such a case, the arrangement of the arrangement interval variation LEDs or the arrangement of the arrangement interval variation LEDs may be altered as appropriate according to the arrangement of the screw member.

(6) In addition to the above embodiments, the arrangement of the screw member or the clip member for attaching the LED board to the chassis may be altered as appropriate.

(7) In the first to fifth and seventh embodiments, the screw member may be replaced with the clip member included in the seventh embodiment.

(8) In the above embodiments, one or two of the screw members or the clip members are attached to the LED board. However, three or more screw members or clip members may be attached to the LED board.

(9) In the above embodiments, the arrangement region of the area variation dots that are included in the light reflection portions of the light guide plate substantially overlaps the arrangement region of the arrangement interval variation LEDs. However, large parts of the respective arrangement regions may overlap each other while other parts thereof may not overlap, or some parts of the respective arrangement regions may overlap each other while large parts thereof may not overlap.

(10) In the above embodiments, the arrangement region of the area constant dots that are included in the light reflection portions of the light guide plate substantially overlaps the arrangement region of the arrangement interval constant LEDs. However, large parts of the respective arrangement regions may overlap each other while other parts thereof may not overlap, or some parts of the respective arrangement regions may overlap each other while large parts thereof may not overlap.

(11) In the second and third embodiments, a pair of the LED boards may be arranged at the respective long-side end portions of the chassis such as those in the fourth embodiment, or the LED boards may be arranged at the respective short-side end portions of the chassis such as those in the fifth embodiment.

(12) In the first to fourth embodiments, as is described in the fifth embodiment, the screw member may be arranged in an eccentric portion of the LED board. Further, the arrangement interval variation LEDs and the arrangement interval constant LEDs may be arranged in asymmetrical. Furthermore, the area variation dots and the area constant dots may be arranged in asymmetrical.

(13) In addition to the above embodiments, the specific variation levels of the intervals between the LEDs may be altered as appropriate.

(14) In the first to sixth embodiments, the LED board may be attached to a heat dissipation member with the screw member or the clip member such as that described in the seventh embodiment.

(15) In addition to the above embodiments, the specific variation levels of the area ratio of the light reflection portions may be altered as appropriate.

(16) In the above embodiments, the screw member and the clip member are used as attaching members to attach the LED board to the chassis. However, in addition to the above members, a rivet member may be used.

(17) In the first to third, sixth, and seventh embodiments, the LED board is arranged on one of the long-side end portions of the chassis. However, the LED board may be arranged on only one of short-side end portions of the chassis.

(18) In the above embodiment, the one LED board is arranged opposite the one end portion of the light guide plate or a pair of the LEDs are arranged opposite the end portions of the light guide plate. However, the LED boards may be arranged opposite the three end portions or all of the four end portions of the light guide plate.

(19) In the above embodiments, one or two LED boards are arranged on one side of the light guide plate. However, three or more LED boards may be arranged on one side of the light guide plate.

(20) In the above embodiments, the color portions of the color filtered in the liquid crystal panel are in three colors of R, G, and B. However, the color portions may be provided in four or more colors.

(21) In the above embodiments, the LEDs are used as light sources. However, other types of light sources such as organic ELs may be used.

(22) In the above embodiments, the TFTs are used as switching components of the liquid crystal display device. A liquid crystal display device including switching components other than TFTs (e.g., thin film diodes (TFDs)) may be included in the scope of the technology. A black-and-white liquid crystal display device other than the color liquid crystal display device may be included in the scope of the technology.

(23) In the above embodiments, the liquid crystal display device including the liquid crystal panel as a display panel is used. However, a display device including other type of display panel may be included in the scope of the technology.

(24) In the above embodiments, the television device including the tuner is used. However, a display device including other type of display panel may be included in the scope of the technology. Specifically, liquid crystal display devices used for digital signage or electric blackboards may be included in the scope of the technology.

(25) In the eighth embodiment, the LED board (or LEDs), the screw member, and the light reflection portion included in the first embodiment and the LED board (or LEDs), the screw member, and the light reflection portion included in the second embodiment are used in combination. However, the LED board (or LEDs), the screw member, and the light reflection portion included in the third embodiment may be combined. Further, the configuration of the eighth embodiment may be applied to the fifth embodiment in which the LED boards are arranged at the respective short-side end portions of the chassis.

(26) In the ninth embodiment, the screw member is located between the main light-emitting surface of the LED and the light entrance surface of the light guide plate. However, the surface of the head portion opposite the light entrance surface may be altered as appropriate. The surface of the head portion opposite to the light entrance surface may be on the same plane with the main light-emitting surface of the LED or on the same plane with the light entrance surface. Further, similar to the ninth embodiment, a surface of the clip member opposite to the light entrance surface in the sixth embodiment may be located between the main light-emitting surface of the LED and the light entrance surface of the light guide plate, or may be on the same plane with the main light-emitting surface of the LED or on the same plane with the light entrance surface.

### EXPLANATION OF SYMBOLS

10, 610: liquid crystal display device (display device), 11, 611: liquid crystal panel (display panel), 12, 612, backlight unit (lighting device), 14, 414, 514, 814: chassis (mount member), 17, 117, 217, 317, 417, 617, 717A, 717B, 817: LED (light source), 18, 118, 218, 318, 418, 518, 618, 718A, 718B, 818: LED board (light source board), 19, 119, 219, 319, 419, 619, 719, 819: light guide plate, 19a: light exit surface (plate surface), 19b, 219b, 319b, 419b, 819b: light entrance surface (end surface, light source opposed surface), 19d: LED non-opposed end surface (light source non-opposed end surface), 22, 122, 222, 322, 422, 622, 722A, 722B, 822: screw member (board attachment member), 23, 123, 223, 323, 423, 723: light reflection portion, 24, 124, 224, 424, 724A, 724B: arrangement interval variation LED (arrangement interval variation light source), 25, 425, 725A: arrangement interval constant LED (arrangement interval constant light source), P1 to P3, P11 to P14, P21 to P24, P41 to P43: interval, P4, P5, P44 to P46: interval, 28: clip member (board attachment member), 29: heat dissipation member (mount member), TV: television device.

1. A lighting device, comprising:
a plurality of light sources;
a light guide plate including an end surface and a plate surface, the end surface being opposite the light sources and through which light from the light sources enters the light guide plate, the plate surface through which light exits the light guide plate;
a light source board where the light sources are arranged at intervals along the end surface of the light guide plate;
a mount member to which the light source board is mounted;
a board attachment member arranged between the light sources adjacent to each other, the board attachment member attaching the light source board to the mount member; and
a plurality of arrangement interval variation light sources included in the light sources and arranged such that the intervals between the arrangement interval variation light sources decrease as a distance from the board attachment member increases.

2. The lighting device according to claim 1, wherein the arrangement interval variation light sources include at least:
a pair of first light sources arranged with the board attachment member therebetween;
a second light source arranged adjacent to at least one of the first light sources such that an interval between the at least one of first light sources and the second light source is smaller than an interval between the pair of first light sources, and
a third light source arranged adjacent to the second light source such that an interval between the second light source and the third light source is smaller than the interval between the at least one of the first light sources and the second light source.

3. The lighting device according to claim 1, further comprising light reflection portions configured to reflect light in the light guide plate toward a light exiting side to increase light exiting from the plate surface of the light guide plate and arranged such that an area distribution of the light reflection portions in a plane of the plate surface of the light guide plate decreases along an arrangement direction of the light sources as the distance from the board attachment member increases.

4. The lighting device according to claim 1, wherein the light sources further include a plurality of arrangement interval constant light sources that are located further away from the board attachment member than the arrangement interval variation light sources and arranged such that the intervals between the arrangement interval constant light sources are constant regardless of the distance from the board attachment member.

5. The lighting device according to claim 1, wherein the arrangement interval variation light sources are arranged such that the intervals therebetween continuously and gradually decrease as the distance from the board attachment member increases.

6. The lighting device according to claim 1, wherein the board attachment member is located at a substantially middle portion of the light source board with respect to an arrangement direction of the light sources.

7. The lighting device according to claim 1, wherein one of outer peripheral end surfaces of the light guide plate is a light source opposed surface that is opposite the light sources and another outer peripheral end surface is a light source non-opposed surface that is not opposite the light sources.

8. The lighting device according to claim 1, wherein the light sources are arranged in symmetrical with respect to the board attachment member on the light source board.

9. The lighting device according to claim 8, further comprising light reflection portions configured to reflect light in the light guide plate toward a light exiting side to increase light exiting from the plate surface of the light guide plate and arranged such that an area distribution of the light reflection portions in a plane of the plate surface of the light guide plate decreases along an arrangement direction of the light sources as the distance from the board attachment member increases, the light reflection portions being symmetrical with respect to the board attachment member along the arrangement direction of the light sources.

10. The lighting device according to claim 1, wherein a projection height of the board attachment member from the light source board is smaller than a projection height of the light sources from the light source board.

11. The lighting device according to claim 1, further comprising a chassis holding the light source board and the light guide plate, the chassis being the mount member.

12. A display device comprising:
the lighting device according to claim 1; and
a display panel configured to provide a display using light from the lighting device.

13. The display device according to claim 12, wherein the display panel is a liquid crystal panel including a pair of substrates and liquid crystals sealed between the substrates.

14. A television device comprising the display device according to claim 12.
